(19) United States
(12) Patent Application Publication
(10) Pub. No.: US 2003/0105820 A1
(43) Pub. Date: Jun. 5, 2003

(54) Method and apparatus for facilitating online communication

(76) Inventors: Jeffrey Haims, Jersey City, NJ (US); Ron Milione, Huntington Station, NY (US); Gene Goldberg, New York, NY (US)

Correspondence Address: BUCKLEY, MASCHOFF, TALWALKAR, & ALLISON, 5 ELM STREET, NEW CANAAN, CT, 06840, US

(21) Appl. No.: 10/154,303

(22) Filed: May 24, 2002

(30) Foreign Application Priority Data
Dec. 3, 2001 (WO) PCT/US01/45187

(51) Int. Cl. G06F 15/16; G09G 5/00

(52) U.S. Cl. 709/205; 709/227; 345/753

(57) ABSTRACT

Embodiments of the present invention provide systems, methods, apparatus, computer program code, user interfaces and means for facilitating online communication.

### CROSS REFERENCE TO RELATED APPLICATIONS

This application claims priority under 35 U.S.C. §§ 119 and 120 to PCT Patent Application Serial No. PCT/US01/45187, entitled “Executive Briefing Network”, filed on Dec. 3, 2001, the contents of which are hereby incorporated by reference in their entirety for all purposes.

### FIELD OF THE INVENTION

The present invention relates generally to electronic communication methods and apparatus. More particularly, embodiments of the present invention relate to methods, systems, apparatus, computer program code and means for facilitating electronic communication among multiple participants.

### BACKGROUND OF THE INVENTION

Advances in telecommunications have changed the way that individuals interact with each other. New devices, such as wired and wireless telephones, computers and networks such as the Internet make it easy for individuals to communicate. Although these advances in communications have made it easier to communicate with others, they have also created new communication difficulties.

For example, in some ways, these new communications devices have made it more difficult to reach others. At any given time, most individuals can be contacted using one or more communication devices. A businessperson typically can be reached via either an office e-mail address, an office telephone number, an office facsimile machine, a home e-mail address, and/or a home telephone number. When the person is not at either his home or business office, he can often be reached on his cellular telephone. The availability of multiple options can make it difficult to contact someone.

In today's fast paced business environment, it is often desirable to quickly determine if a person is available for an on-line communication session, and if so, quickly join the person in an on-line communication session. It would be desirable to provide systems and methods which track these options and allow individuals to be readily contacted. It would further be desirable to provide systems and methods which allow individuals to be quickly contacted and involved in communication sessions with one or more other individuals. It would further be desirable to provide systems and methods which track the accessibility of individuals, allowing an initiator of a communication session to quickly ascertain the availability or non-availability of a potential participant.

Advances in communications have further failed to provide an adequate solution to the problem of facilitating communication among multiple individuals. For example, Applicants are not aware of any satisfactory solution to the following example scenario. A number of individuals wish to meet to review and discuss a draft document produced by another individual. Currently, review of such a document is performed in a number of ways. Each participant may print a copy of the draft and mark it up for later discussion. Alternatively, each participant may electronically edit the document and forward the revised document to one of the participants designated as the individual responsible for collating comments from each of the reviewers. A conference call or face-to-face meeting may also be held to discuss any comments. This iterative, sequential process can be inefficient and time consuming.

Further, the approach can lead to miscommunications and misunderstandings among participants who do not have the ability to discuss comments and concerns with other participants. Further still, one or more of the participants may utilize a software program that is not compatible or available to the systems operated by one or more of the other participants. A still further problem lies in the difficulty of managing access privileges and permissions among participants from multiple companies. It would be desirable to provide a system and method which allows access privileges and permissions to be accurately assigned and maintained, thereby ensuring that individuals from different companies or entities can communicate and collaborate.

Tools and systems have been proposed to assist in such communications. For example, presentation and document sharing tools have been developed which allow multiple participants to view the same document over the Internet. Unfortunately, these tools do not allow the sharing of any type of document produced by any type of software. Further, Applicants are unaware of any tools that allow any or all of the participants to mark-up or annotate the shared document. It would be desirable to provide systems and methods allowing individuals to jointly view, edit and manipulate documents even where the document format is not compatible with the systems of one or more of the participants. Preferably, such systems and methods would further support voice, text, and video interaction between the participants in a secure and user friendly manner.

A number of tools have been developed which allow individuals to utilize computers as communication platforms. For example, a computer equipped with a microphone and appropriate software and which is in communication with the Internet can be used to initiate and receive voice telephone calls. A computer further equipped with a video camera can be used to initiate and receive video conference calls. Such existing tools are commonly provided as separate applications or applications which utilize Microsoft Windows®-style windowing or tiling techniques. When multiple applications or sessions are in use, it can be difficult and inefficient for a user to switch between applications. This problem is exacerbated when the computer is further utilized to support communication sessions where one or more documents are being viewed by multiple participants. It would be desirable to provide user interfaces and tools which allow participants to securely, efficiently and readily manage and initiate interactions with others.

### SUMMARY OF THE INVENTION

Embodiments of the present invention provide systems, methods, apparatus, computer program code, user interfaces and means for facilitating online communication.

Pursuant to some embodiments of the present invention, methods, apparatus, systems, computer program code, and means for operating a computing device to initiate a communication session are provided which include: detecting if a desired participant is available to participate in a communication session; transmitting an invitation to said desired participant if said desired participant is available; receiving an acceptance from said desired participant, wherein said transmitting and said receiving are performed in substantially real time; and upon receipt of said acceptance, automatically causing meeting information to be forwarded to a communication server, said communication server establishing said communication session involving said meeting initiator device and said desired participant. Pursuant to some embodiments of the present invention, this initiation of a communication session may include the use of instant messaging to initiate the communication session.

Pursuant to some embodiments of the present invention, methods, apparatus, systems, computer program code, and means for operating a computing device to provide a communications user interface are provided which includes an action section for presenting to the user a plurality of selectable communication type icons; an outline section for presenting to the user a plurality of communication-related data; and a content section including a frame for allowing the display and manipulation of a second software application by the user. Pursuant to some embodiments of the present invention, at least a portion of the action section is presented in an upper portion of a display of a computing device. In some embodiments, at least a portion of the outline section is presented in a right portion of a display of a computing device, in some embodiments, at least a portion of the content section is presented in a lower section of a display of a computing device. In some embodiments, the action section, the outline section and the content section do not overlap, thereby reducing an opportunity for the user to accidentally select an incorrect function on the user interface. The second software application is not required to be resident on the first computing device. Embodiments of the present invention permit the integration and management of a number of communications functions, using, for example, a plurality of selectable communication type icons including at least one of: an online communication icon, a video communication icon, an audio communication icon, and a text message communication icon.

Pursuant to some embodiments of the present invention, methods, apparatus, systems, computer program code, and means for providing a user interface for a network communications software application includes: an action section having at least a portion thereof presented in an upper half of a display of a first computing device during use of a first software application, the action section including a plurality of selectable action icons, the selection of any of which by a first user of the computing device initiates at least one of the following processes between the first user and a second user having a second computing device in communication with the first computing device over a communications network: an online communication with a productivity application, a video communication, an audio communication, and a text message communication; an outline section having at least a portion thereof presented in a right half of the display of the first computing device, the outline section including a plurality of selectable function icons and a plurality of communications data fields, the plurality of selectable function icons comprising at least one of: a telephone keypad with selectable numeric keys, a volume control including a mute function, and a conference disconnect control; the plurality of communications data fields comprising at least one of: a name of a party to a conference, a name of other attendees of the conference, an indication of a host of the conference; an address book of comprising addresses of other users available for the conference; and a content section having at least a portion thereof presented in a lower half of the display of the first computing device, the content section including a frame for allowing the display and manipulation of a second software application by the first user, wherein the second software application is not required to be resident on the first computing device.

Pursuant to some embodiments of the present invention, methods, apparatus, systems, computer program code, and means for initiating an online conference using a network communication software application on a first computing device are provided which include: selecting a communication type icon for initiating one of the following processes of an online conference: an online communication of a productivity application, a voice communication, a video communication and a text messaging communication; selecting an attendee for the online conference; and transmitting a text message for display on a computing device of the selected attendee, wherein the attendee may select an alternate destination for the display of the text message when the attendee is not using a second computing device having a network address assigned to the attendee.

Pursuant to some embodiments of the present invention, methods, apparatus, systems, computer program code, and means for facilitating communications between a plurality of users are provided which include establishing a first user using a first computing device as a moderator of an online conference; establishing a second user using a second computing device as an attendee of the online conference; receiving, from the moderator, an indication of a software application and content managed by the software application to make available to the attendee, the software application resident on the first computing device; and receiving from the attendee a revision to the content generated in a content section of a display of the second computing device during the online conference. Pursuant to some embodiments of the present invention, a passport function is provided in which security and other preference attributes associated with a user can be established and permanently associated with the user, permitting the user to move within and between organizations while maintaining preferences.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 is a schematic block diagram of an exemplary communication network according to some embodiments of the present system;

FIG. 2 is a schematic block diagram of a further exemplary communication network according to some embodiments of the present system;

FIG. 3 is a schematic block diagram of the communication network of FIG. 1 showing details of user devices, communication server, and related data;

FIG. 4 is a tabular representation of a portion of a domain hierarchy database according to an embodiment of the present invention;

FIG. 5 is a tabular representation of a portion of a user database according to an embodiment of the present invention;

FIG. 6 is a tabular representation of a portion of a communication database according to an embodiment of the present invention;

FIGS. 7A-C are schematic diagrams depicting examples of domain hierarchies in which intercommunication among users is facilitated using features of embodiments of the present invention;

FIG. 8 is a flowchart depicting an exemplary process performed by a user of the communication network of the present system;

FIGS. 9A-B are schematic block diagrams depicting message flow to establish an ad hoc communication session pursuant to embodiments of the present invention;

FIGS. 10A-Q are illustrations of user interfaces presented to a user during communications using the communication network of FIG. 1; and

FIG. 11 is a schematic block diagram depicting an embodiment of the system of FIG. 1 configured to support establishment of instant meetings pursuant to embodiments of the present invention.

### DETAILED DESCRIPTION OF THE INVENTION

Applicants have recognized a need for systems, methods, apparatus, computer program code, user interfaces, and means for facilitating online communications among individuals in a secure manner. Applicants have recognized that this communication may be facilitated using passport security techniques which ensure that individual user preferences are maintained as the user moves within the system. Further, Applicants have recognized that security techniques are needed to ensure that users from different organizations can communicate in a secure fashion.

Applicants have further recognized a need for systems, methods, apparatus, computer program code, user interfaces and means for initiating and conducting ad hoc communication sessions or sessions initiated and conducted in a short period of time. Applicants have further recognized a need for user interfaces which allow multiple communication and collaboration tools to be manipulated and presented in an efficient and readily accessible manner. For example, Applicants have discovered that the use of a “container” or workspace in conjunction with a control interface allows users to easily manage and control the convergence of instant message (“IM”) information delivery, document, application and desktop sharing as well as communication and collaboration technologies such as audio, video, text and other programs.

A number of terms are used herein to describe features of embodiments of the present invention. For example, as used herein, a “participant” is an individual operating a communication device (including a computing device, wired or wireless telephone, etc.) to participate in a communication session, conference or meeting using techniques of embodiments of the present invention.

As used herein, the term “communication session” or simply “session” is used to refer to a meeting, conversation, or other interactive communication between one or more participants using techniques of embodiments of the present invention. A communication session may include audio, video, text or other interaction among participants. A communication may also include interactive collaboration among participants (e.g., to discuss a document displayed on a display monitor of a computing device operated by each of the participants). As used herein, a “collaboration session” is a communication session which involves the sharing of one or more computer applications and/or documents among participants. A collaboration session may also involve voice, text, and/or video communications among one or more participants.

As used herein, participants in a communication session include one or more “attendees” and a “host”. As used herein, the term “host” is used to refer to a participant in a communication session who initiates the session. Further, the host in a collaboration session is the participant who is designated (which designation may change throughout the collaboration session) as having the ability to control certain interactions or access rights of the other attendees during the session. In general, the attendee who initiates a collaboration session will initially be designated as the “host” and will have the ability to pass control to other attendees as well as to revoke the designation.

System Overview

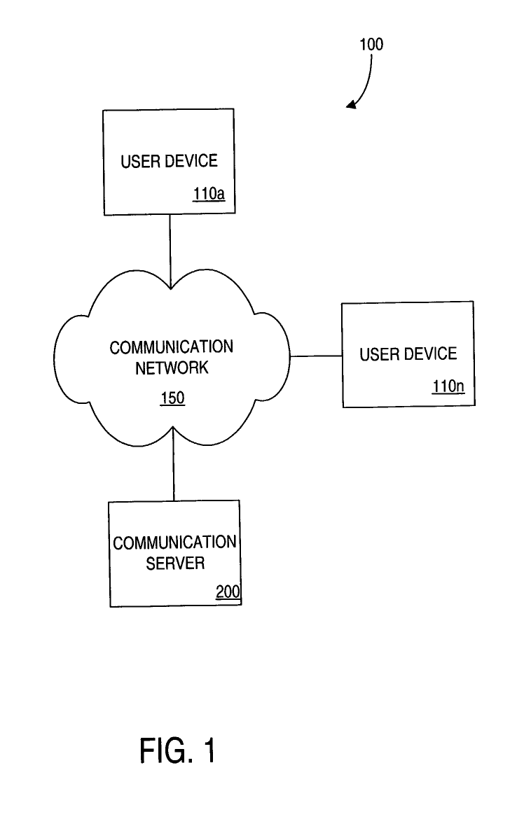

Reference is now made to the figures wherein similar components of embodiments of the present invention are referenced in like manner. Reference is first made to FIG. 1 where a communication system 100 pursuant to one embodiment of the present invention is depicted. As shown in FIG. 1, communication system 100 includes a plurality of user devices 110a-n in communication with each other and a communication server 200 over a communications network 150. Pursuant to embodiments of the present invention, users operating user devices 110 may interact with each other. This interaction can include audio, video, text, and other forms of communication as will be described further herein. Further, this interaction can include collaboration among users in which users operating user devices 110 may jointly view and manipulate applications and/or documents.

User devices 110 may be any of a number of different types of devices which may be used to engage in various forms of communication such as voice, video, text or graphical interaction. For example, some user devices 110 may be a computer, such as those based on the Intel® Pentium® processor, that are adapted to communicate via network 150. The computer may be configured in any of a number of different manners, such as, for example, as a desk-top computer, lap-top computer, handheld computer, personal digital assistant (PDA), or the like. Each user device 110 may operate software applications allowing the device to communicate via network 150 and to send and receive information pursuant to embodiments of the present invention. Such user devices 110 may be configured with voice input and output devices and, in some embodiments, with video capture and display devices as are known in the art. Some user devices 110 may be telephones (either wired or wireless) which send and receive voice data and, in some embodiments, text messages. Other user devices 110 now known or later developed which enable communication between individuals may also be used with the communication system of the present invention.

Each participant in communication system 100 may operate one or more user devices 100. For example, a particular participant may operate both a home and an office computer as well as an office telephone and a cellular telephone, each of which is in communication with communication server 100 via network 150. As will be described below, the participant may designate which user devices he wishes to designate as “online” or otherwise available for use in communication sessions pursuant to embodiments of the present invention. This status may be changed by the participant (e.g., the office computer may be designated as “online” during working hours, and the home computer may be designated as “online” on evenings and weekends while the office computer will be designated as “offline” during those times). The participant may have multiple devices all “online” at the same time depending on situation and need. Embodiments of the present invention manage these multiple devices and the status of all participants using persistent real-time parallel state control. For example, a communication server may be used to perform state control of all devices that are logged on or registered with the system. As used herein, “state control” is used to refer to the status or availability of each device registered with the system (e.g., a device may be “available” or “online” or it may be “unavailable” or “offline”). Embodiments of the present invention track this state information based, at least in part, on information provided by each participant.

Embodiments of the present invention permit interactions between different types of user devices. For example, embodiments of the present invention facilitate collaborations between users operating personal computers and users operating wired or wireless telephones or the like.

As used herein, communication network 150 may employ any of a number of different types and modes of communication, and may be for example, a Local Area Network (LAN), a Metropolitan Area Network (MAN), a Wide Area Network (WAN), a proprietary network, a Public Switched Telephone Network (PSTN), a Wireless Application Protocol (WAP) network, a wireless network, a cable television network, or an Internet Protocol (IP) network such as the Internet, an intranet or an extranet. Moreover, as used herein, communications include those enabled by wired or wireless technology.

According to some currently preferred embodiments, communication between user devices 110a-n and communication server 200 is supported by implementation of telecommunication standards including International Telecommunication Union (ITU) recommendation H.323 “Packet-Based Multimedia Communications Systems” and ITU recommendation T.120 “Data Protocols for Multimedia Conferencing”, the contents of each of which are incorporated herein in their entirety. H.323 specifies components, protocols and procedures for real-time point-to-point and multipoint multimedia communication over packet-based networks and also establishes interoperability guidelines. In an embodiment implemented using H.323, each user device 110 may be configured as an H.323 client or endpoint where H.323 data streams and signaling originate and terminate. For example, such user devices 110 may be configured with a H.323 compliant stack, SIP Client Stack or a standalone device such as PDA using universal serial bus (USB) and IP telephone. In some embodiments, one or more gateway devices may also be provided to facilitate communication between different networks.

Communication server 200 may be configured in any of a number of ways known to those skilled in the art, such as, for example, an Intel® Pentium® based-computer or the like. In some embodiments, a number of communication servers 200 may be utilized to support different groups of user devices. In an embodiment where the network is configured using H.323, SIP protocols, communication server 200 may be configured as a H.323 or SIP gatekeeper device providing central management and control services.

In one embodiment, communication server 200 is configured as one or more servers or devices performing related functions. For example, communication server 200 may include a Web server configured to communicate with user devices 110a-n via the Internet. The Web server may function to generate Web pages (documents on the Web that typically include an HTML file and associated graphics and script files) that may be accessed via the Web and allow communication with user devices 110a-n in a manner known in the art. The Web server may be in communication with and one or more back end servers such as a media server and an application server. The Web server may also be in communication with one or more databases, such as, for example, one or more databases used to store information used to manage and facilitate communications between participants. In one embodiment, communication server 200 is based on several components, including, for example, a Harmony6000 application server manufactured by IP Unity, Inc. of Milpitas, Calif. (which is used as a conference bridge). Those skilled in the art will recognize that other devices may also be used to provide the functions and capabilities described herein. Pursuant to some embodiments, communication server 200 is implemented to reduce dependency on individual communication components. For example, other conference bridging software may be used. As another example (as will be described further below), communication server 200 may interface with communication software provided by other parties. In this manner, systems implemented pursuant to embodiments of the present invention may be updated with new communication functionality as new products are made available.

In some embodiments, communication between user devices 110a-n is performed in a client-server relationship where communications are routed through communication server 200. In some embodiments, communication between user devices 110a-n may involve direct interaction between user devices 110a-n in a peer-to-peer relationship. Any number of user devices 110a-n and communication servers 200 may be in communication with each other via network 150. Any number of different devices and operating systems are supported using embodiments of the present invention (for example, different user devices 110 may operating using different operating systems such as Windows®, Unix, Macintosh®, Linux, or the like).

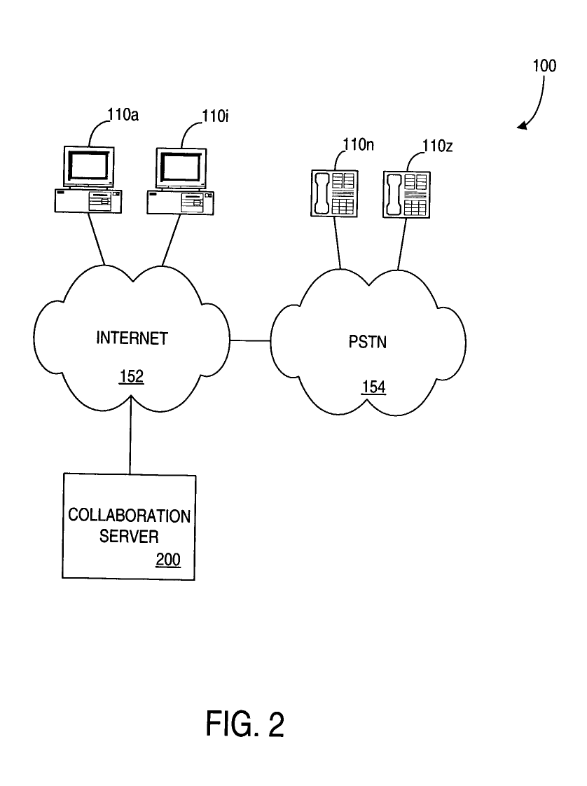

Referring now to FIG. 2, a further example of communication system 100 is depicted. As shown in FIG. 2, a number of different types of user devices 110 may be used in conjunction with embodiments of the present invention. For example, communication session attendees may operate computing devices (such as, for example, personal computers, laptops, PDAs, or the like) 110a-i to interact with communication server via the Internet. Some communication session attendees may operate telephones (either wired or wireless) 110n-z to interact with communication server 200 via the public switched telephone networks (PSTN) or other telephone networks. In some embodiments, a gateway or gatekeeper device (not shown) is used to establish communication between the PSTN and communication server 200.

Devices

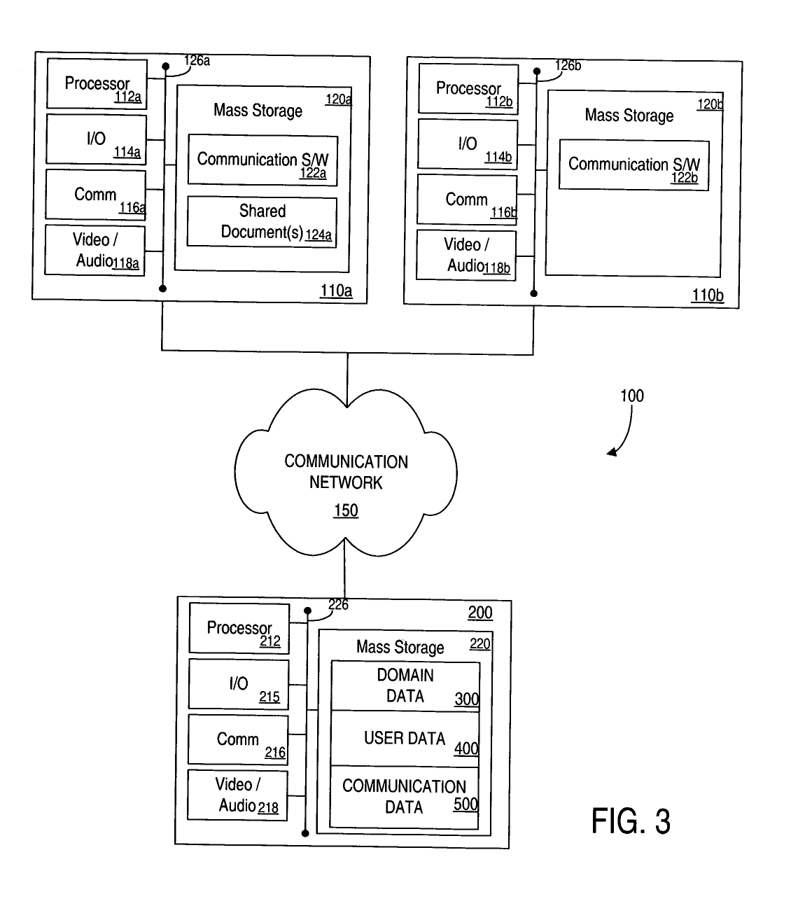

Referring now to FIG. 3, a further example of communication system 100 is shown. In the example system 100 of FIG. 3, details of two exemplary user devices 110a, b are shown. In the depicted example, each of the exemplary user devices 110a, b are computing devices (e.g., such as personal computers or the like). Each of the user devices 110a, b are in communication with each other and with communication server 200 via a network 150. In the depicted example, network 150 is the Internet. Other devices (not shown) may be in communication with user devices 110a, b. For example, one or more wired or wireless telephones or other devices may be in communication with user devices 110a, b. In some embodiments, communication between and among these devices is facilitated through persistent state control among devices. For example, embodiments of the present invention track, monitor, and maintain information about the availability and status of individual devices and users (e.g., tracking information such as user rights, logon validation policies and security parameters/constraints at all times allowing access and user login validation to the system).

As illustrated, each user device 110 includes a microprocessor 112 in communication with a communication bus 126. Microprocessor 112 may be a Pentium®, RISC®-based, or other type of processor and is used to execute processor-executable process steps so as to control the components of user device 110 to provide desired functionality. Also in communication with communication bus 126 is a communication port 116. Communication port 116 is used to transmit data to and to receive data from external devices, such as, for example, other user devices 110 via a network such as the Internet. Pursuant to embodiments of the present invention, communication port 116 is also used to transmit data to and to receive data from communication server 200 (e.g., over a network such as the Internet). Communication port 116 is therefore preferably configured with hardware suitable to physically interface with desired external devices and/or network connections. In one embodiment, communication port 116 (and associated software drivers and utilities) are configured to support communications protocols such as the H.323 and T.120 protocols.

One or more input/output (I/O) devices 114 are also in communication with processor 112 via communication bus 126. Any known input and output devices may be used, including a keyboard, mouse, touch pad, voice-recognition system, display, printer, or any combination of these devices. I/O devices 114 may be used by a user to input and view information. For example, a user may utilize I/O devices 114 to initiate and participate in communication sessions pursuant to embodiments of the present invention.

Each user device 110, as depicted, also includes one or more video/audio devices 118. Pursuant to some embodiments of the present invention, audio input and output devices (e.g., such as microphone, speakers, etc.) are provided to allow a user to utilize user device 110 to initiate and receive calls. In some embodiments, user device 110 may further include a video capture device allowing the user to utilize user device 110 to generate video data (e.g., for use in video conference calls). Any of a number of video and/or audio devices may be used in conjunction with user device 110. According to some embodiments, the video and/or audio devices are compliant with Internet telephony standards such as H.323 and T.120. Those skilled in the art will recognize that video/audio devices 118 may also include encoding and decoding software (“codecs”) such as those specified in H.323 which are utilized to encode and decode video and audio files used in accordance with embodiments of the present invention.

Each user device 110 also includes one or more memory devices coupled to communication bus 126, such as, for example, random-access memory (RAM) (not shown), read-only memory (ROM) (not shown), and mass storage device 120. RAM may be used, for example, to provide microprocessor 112 with fast data storage and retrieval. In this regard, processor-executable process steps being executed by microprocessor 112 are typically stored temporarily in RAM and executed therefrom by microprocessor 112. ROM may be utilized to provide storage from which data can be retrieved but to which data cannot be stored. Accordingly, ROM is typically used to store invariant process steps and other data, such as basic input/output instructions and data used during system boot-up or to control communication port 116.

Mass storage device 120 may be any of a number of known computer-readable storage mediums, such as, for example, a floppy disk, a CD-ROM, a DVD-ROM, a Zip drive, a magnetic tape, hard drive, or the like. Mass storage device 120 stores, among other data, a browser program including processor-executable process steps used to allow a user to interact with Web pages displayed by communication server 200, allowing the user to establish and participate in communication sessions pursuant to embodiments of the present invention. The browser program may be, for example, a commercially-available browser program such as the Internet Explorer®.

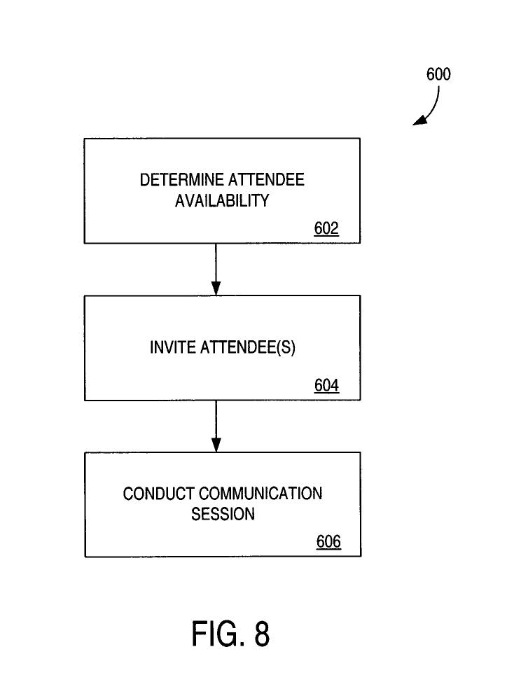

Microprocessor 112 executes stored instructions to cause user device 110 to operate in accordance with the process steps described in detail herein. For example, as depicted, mass storage device 120 stores communication software 122 or client software which facilitates interaction with communication server 200 and with other user devices 110. Communication software 122 may include executable code which allows a user operating user device 110 to initiate a communication session, initiate a voice or text message session, manage communication session preferences, manage address and contact information, etc. An example of certain functionality of communication software 122 will be presented below in conjunction with the discussion of FIG. 8.

Communication software 122 may also include commercially-available communication tools. Pursuant to some embodiments of the present invention, a communication system is provided which facilitates the integration and utilization of individual communication tools. For example, user device 110 may include several communication software components, such as collaboration software, Internet telephony software, video software, etc. As a specific example, user device 110 may be configured with collaboration software from WebEx® and Internet telephony software from VocalTech®. Pursuant to embodiments of the present invention, each of these communication tools is integrated through a convenient graphical user interface which will be described further below. Pursuant to embodiments of the present invention, these communication tools may be any custom-developed or commercially-available tools now known or later developed.

Mass storage device 120 may also store data, such as, for example, documents or other information to be shared in a communication session conducted pursuant to embodiments of the present invention. Pursuant to embodiments of the present invention, communication session participants may jointly view and manipulate data resident on other participant devices. As shown in the example of FIG. 3, the user operating user device 110a has one or more shared document(s) 124a stored on his mass storage device 120a. Pursuant to embodiments of the present invention, other participants in a communication session may view, manipulate, and edit the shared document(s) 124a from their computers (e.g., the user operating user device 110b may remotely view and edit shared document(s) 124a). Similarly, during the course of a communication session involving user devices 110a, b, the user operating user device 110b may make one or more documents stored in his mass storage device 120b available to the user operating user device 110a. Pursuant to some embodiments of the present invention, this may be accomplished securely and in an efficient manner.

Data and instructions in mass storage device 120 may be stored in a compressed, uncompiled and/or encrypted format. In alternative embodiments, hard-wired circuitry may be used in place of, or in combination with, processor-executable process steps for implementation of the processes of the present invention. Thus, embodiments of the present invention are not limited to any specific combination of hardware and software.

Communication server 200 may include similar components as user devices 110 (e.g., communication server 200 may be configured with one or more processors 212 in communication with I/O devices 214, video/audio devices 218, storage devices 220 and communications devices 216). As depicted in FIG. 3, communication server 200 is in communication with storage device 220 storing data used to manage communication sessions pursuant to embodiments of the present invention. For example, as depicted, storage device 220 stores data including domain data 300, user data 400 and communication data 500.

Databases

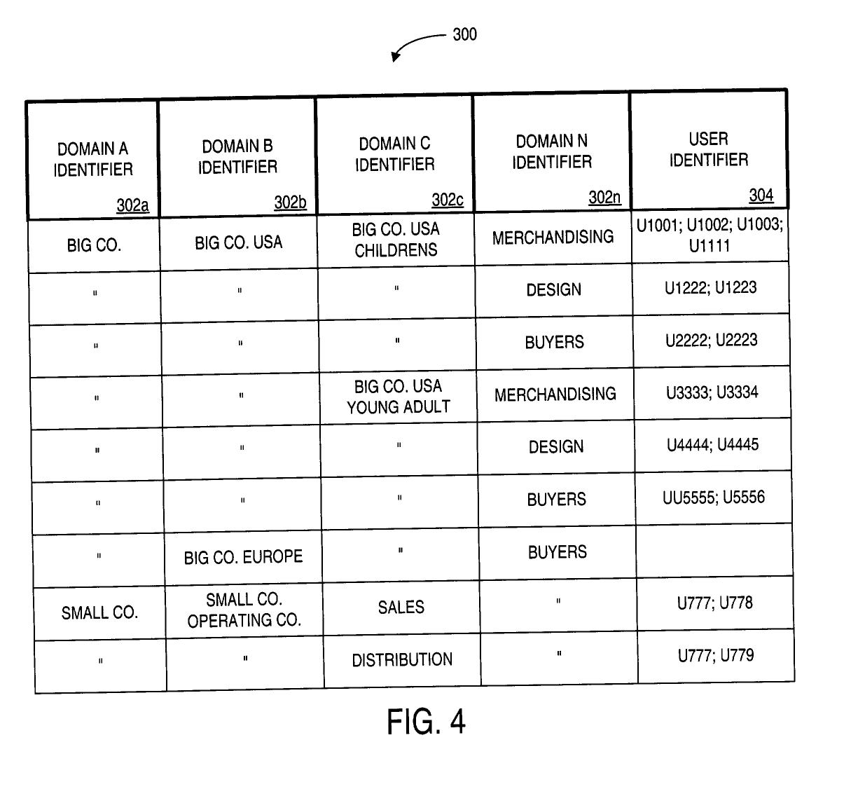

Domain data 300 may include, for example, data identifying one or more domains identifying different groupings with which a particular user may be associated. For example, a group of domains may be used to identify a particular hierarchy of a company utilizing features of embodiments of the present invention to facilitate communication. Further details of exemplary domains will be provided further below in conjunction with a discussion of FIG. 4.

User data 300 may include, for example, data identifying one or more users, including data identifying user location and address information as well as user configuration preferences. This data may be established, for example, during a registration session conducted by or on behalf of a new user. This data may also be updated as requested by a particular user. Communication data 500 may include, for example, data identifying one or more communication sessions established pursuant to embodiments of the present invention. Examples of user data 300 and communication data 400 will now be provided by reference to FIGS. 4, 5 and 6, respectively.

Referring now to FIG. 4, a table 300 represents domain data that may be stored at (or accessible to) communication server 200 according to some embodiments of the present invention. The table includes entries identifying different domains in a hierarchy which utilize features of embodiments of the present invention to facilitate intercommunication among users. A domain hierarchy may include any of a number of different domains (such as domains “a” through “n”). Domain database is used to associate one or more users with particular domain hierarchies. A number of fields 302a-n and 304 are depicted in FIG. 4, including a number of domain identifiers 302a-n (for storing data identifying particular domains or sub-domains a-n) and one or more user identifiers 304 associated with the domain hierarchy defined by domain identifiers 302a-n. Pursuant to some embodiments, a global domain (or top-level domain) is provided which allows entities (such as, for example, a company which uses embodiments of the present invention) to connect with other entities and to create communication bridges with those other entities and other participants.

Pursuant to embodiments of the present invention, a company or other entity may establish a domain hierarchy associating each employee or user with a particular level or levels in the domain hierarchy. In this manner, security and access permissions as well as controlling the look, behavior, or interaction levels of the application, captured in the form of policies, themes and function permissions that can be subsequently be inherited and may be associated with each individual user. “Function hierarchies” may be inherited and associated with individual users include the ability to perform or utilize different communication functions provided by embodiments of the present invention.

Further, security, function and access permissions may be associated with different domains, sub-domains, or other groupings. The result is a security and function hierarchy which facilitates the efficient and accurate assignment and management of access permissions and rights. As will be described further below, this security and function hierarchy is used to facilitate communication between individual users, even where individual users are associated with different companies or other entities.

For example, as shown in FIG. 4, table 300 includes data defining domain hierarchies for one or more entities. A hierarchy of sub-domains is associated with each top level domain (shown as “Domain A” of FIG. 4). Each domain may be identified using a unique alphanumeric identifier. In the embodiment shown, domain hierarchies are depicted for two fictional entities: “Big Co.” and “Small Co.”. Each of these entities may have a number of different divisions, departments, sub-departments or other groupings. Each of these entities may have a number of employees assigned to or otherwise associated with each of these domains. Applicants have found that the use of a hierarchical domain structure allows convenient and flexible assignment of access rights and permissions to individual users. More particularly, Applicants have discovered that such a hierarchical domain structure allows users at different companies or entities to intercommunicate in a secure and controlled manner. Pursuant to some embodiments, each user is assigned a unique user identifier or serial number. This unique identifier is associated with each individual user. The unique identifier is preferably not permanently linked to a particular corporate email address or other network identifier which could change if the user moves within an organization or moves to a new organization. By providing a unique identifier or serial number associated with the individual, the individual can freely move among or between organizations while maintaining communication preferences and identity within the communication system of the present invention.

Pursuant to some embodiments, the user identifier is alphanumeric in nature and allows for a number of user aliases to be associated with the user identifier over the lifetime of its use. For example, the user identifier may be associated with a user's email addresses as the user moves between jobs (e.g., JohnDoe@xyz.com, JohnDoe@BigCo.com, and JohnDoe@SmallCo.com may all identify the same person and may all be associated with the same unique user identifier assigned pursuant to the present invention). Pursuant to some embodiments, this unique user identifier is associated with one or more attributes so that user “John Doe” can be uniquely found and identified even if he has gone through a number of email, address and company or employment changes. Further, the user “John Doe” can be uniquely identified even if he has multiple email addresses and even if another individual having the same name(e.g., “John Doe #2”) becomes in the employ of the former company of the first “John Doe”.

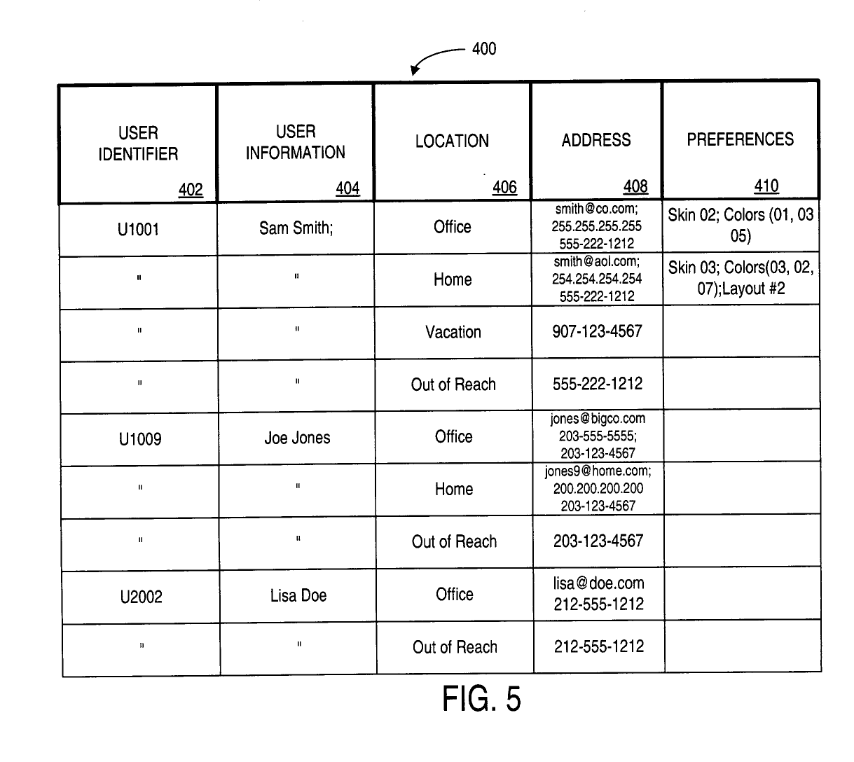

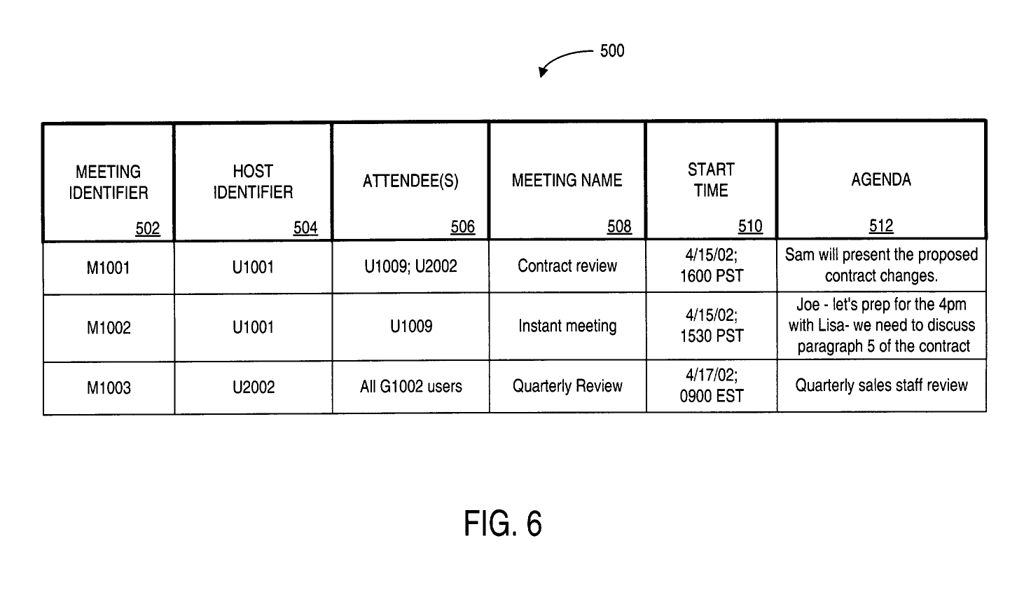

For example, a user such as user “U1001” (who is associated with Big Co. USA, in the merchandising group of Big Co. USA Children's division) can be assigned particular access rights and permissions allowing him to access certain applications and documents. This user can be permitted to interact with certain other users including users associated with different companies (e.g., such as user “U777” who is associated with Small Co. in their sales group). Pursuant to some embodiments of the present invention, each user's access rights and permissions may be regulated and created based on this hierarchical structure. When a user moves or changes positions, his access rights and permissions may change, without changing the user's preferences (which will be discussed further below in conjunction with FIG. 5). Those skilled in the art will recognize that the data representations of FIG. 4 (as well as those of FIGS. 5 and 6 below) are presented for explanatory purposes only, and that other representations, configurations and formats may be used. Further, although three separate tables are shown, those skilled in the art will recognize that one or more database structures may be used to store the described data. Further still, those skilled in the art will recognize that other data elements may also be provided. For example, table 300 may further include specific permissions or access rights associated with each domain or grouping. Alternatively or in addition, a separate database of permissions data may also be provided.

Referring now to FIG. 5, a table 400 represents user data that may be stored at (or accessible to) communication server 200 according to some embodiments of the present invention. The table includes entries identifying users who have registered to participate in communication sessions using embodiments of the present invention. Each of the users is associated with one or more domains (e.g., as shown in FIG. 4) and is further associated with one or more access permissions, rights, themes and/or policies

The table also defines fields 402-410 for each of the entries. As depicted, the table includes fields for data including: a user identifier 402 (identifying a particular user who is registered to utilize features of embodiments of the present invention); user information 404 (including information further identifying the user identified by user identifier 402); location information 406 (specifying one or more user devices at which the user identified by user identifier 402 may be reached); address information 408 (identifying one or more electronic addresses associated with the user devices identified at 406); and preference data 410 (identifying configuration preferences of the user identified by user identifier 402).

The information in table 400 may be created and updated, for example, based on information detected and captured during a registration process involving a user operating user device 110. The information in table 400 may also be updated on an as-needed basis to identify user locations, addresses and preferences. Those skilled in the art will realize that other data items may also be provided to further identify users who participate in communication sessions pursuant to embodiments of the present invention. For example, table 400 may also include updated information regarding the location of individual users. For example, a user may indicate that he will be on vacation for the week of April 15, returning to the office on April 22 and to have all calls forwarded to any number of devices or telephone number of choosing. A user may also indicate that he will be “out of reach” during the afternoon of May 1. This information may be used, as will be described further below, in the creation of communication sessions. Other configuration and preference data may also be stored at or accessible to communication server 200.

In the example data shown in table of FIG. 5, three different users are shown (users U1001, U1009 and U2002). As shown, each of the users is associated with one or more different “locations” (e.g., “office”, “home”, “vacation”, or “out of reach”), each of which is associated with one or more addresses. For example, user 1001 (“Sam Smith”) can be reached at one of four locations. Further, when Sam Smith is at his office, he can be reached via two different communications means—a work electronic mail address, and a work telephone number. According to some embodiments of the present invention, each user can establish one or more addresses allowing him to be contacted at various locations (e.g., office, home, etc.).

Pursuant to some embodiments of the present invention, each user can indicate one or more preferences. In some embodiments, for example, a user may customize aspects of the user interface used on a particular user device. For example, user “U1001” may indicate that he always wishes his user devices to use a particular “skin” (or interface) with particular colors. The preferences may be configured differently for different user devices which are associated with “U1001” (e.g., his office computer may use a different “skin” than his home computer). Other preference information may also be established and maintained for each user, allowing the user to customize a communication environment. Pursuant to some embodiments, this customized communication environment follows the user, even if the user changes positions or domains within a company or even moves to a position with a different company. In some embodiments, when the user is traveling from home where he has a personal account and work where he has a separate work account, embodiments of the present invention identify the user as the same person. In some embodiments, one account of the user may be given a superior status (e.g., the corporate or receiving account may take the superior status and the home account may take on an inferior status). In this manner, if the user modifies one or more attributes of his corporate account, the same attributes may be automatically enforced at the inferior account. In some embodiments, the inferior account may further inherit security, theme, and policy profiles of the corporate account. The result is a customized, comfortable, user friendly interface and communications environment which can be retained by a user despite changes in user devices or domains.

Reference is now made to FIG. 6 where a table 500 is shown depicting communication data that may be stored at or accessible to communication server 200. Communication data includes, for example, data used to plan, manage, and conduct certain communications sessions pursuant to embodiments of the present invention. Data may be provided for table 500 when a “host” user establishes a meeting. Pursuant to embodiments of the present invention, data in table 500 may include planned or scheduled meetings as well as ad hoc meetings.

Table 500 includes a number of fields 502-512 defining communications sessions pursuant to embodiments of the present invention. For example, table 500 may include data such as a meeting identifier 502, a host identifier 504, one or more attendee(s) 506, a meeting name 508, a start time 510, and an agenda 512. Those skilled in the art will appreciate, upon reading this disclosure, that other data items may also be provided.

Meeting identifier 502 may include data uniquely identifying a particular meeting or communication session. Host identifier 504 may include data identifying the particular user (such as one of the users from user database 400) who created or initiated the meeting identified by meeting identifier 502. Attendee(s) 506 includes data identifying one or more users who have been invited to participate in the meeting identified by meeting identifier 502 by host identifier 504. Meeting name 508 may include information identifying the name or topic of the meeting. Start time 510 may include information identifying, for example, the date and time on which the meeting identified by meeting identifier 502 is scheduled to start. For an ad hoc meeting, the information in 510 may be the same as the time of the invitation. Agenda 512 may include information describing a particular agenda for the meeting identified by meeting identifier 502. As will be described, the data of databases 300, 400, and 500 may be used to initiate, manage, and conduct communications sessions among diverse participants in an efficient and effective manner.

Passport Function

Pursuant to some embodiments of the present invention, a database driven “passport” feature allows for the rights and privacies of an individual user and at the same time provides that certain data elements and profiles can be passed to a corporation or entity with which the user is associated through a temporary security visa. In some embodiments, the temporary security visa is configured to possess one or more sockets that receive one or more plug-in tokens containing varying types of security information and features such as, level of security (high, medium, low) or type of security (128 bit, SSL, DES or others).

Pursuant to some embodiments of the present invention, a robust security environment allows a corporation to manage individual users and strategically planned groups that can inherit security rights and privileges instead of trying to manage mass amounts of individual users on a one-to-one basis. This model facilitates collaboration and communication access across internet corporate networks, extranets, other networks owned by the company's clients, suppliers, or vendors and the public internet for connectivity.

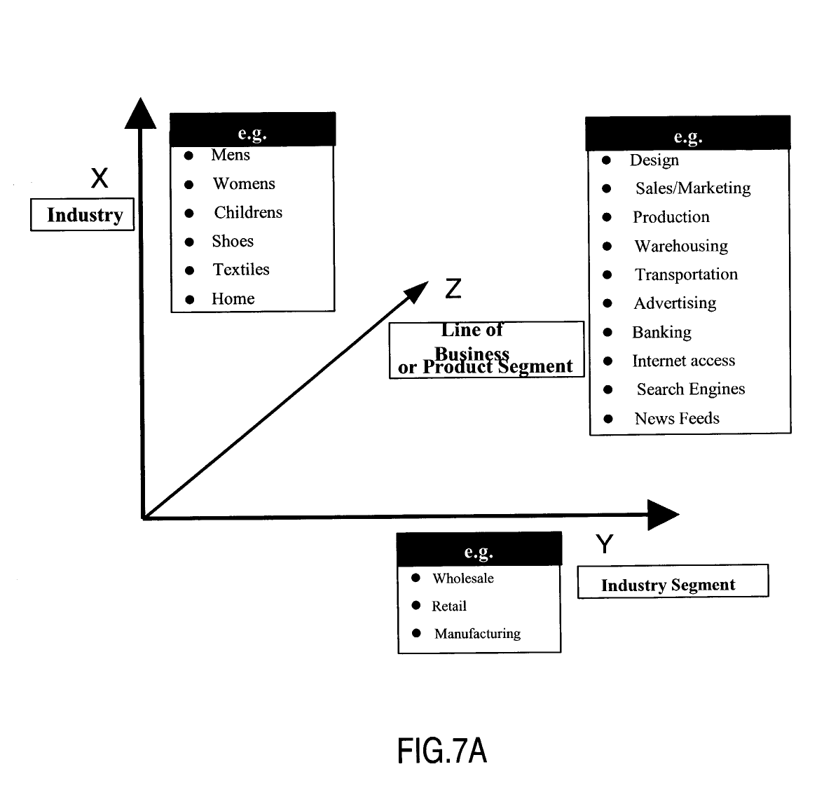

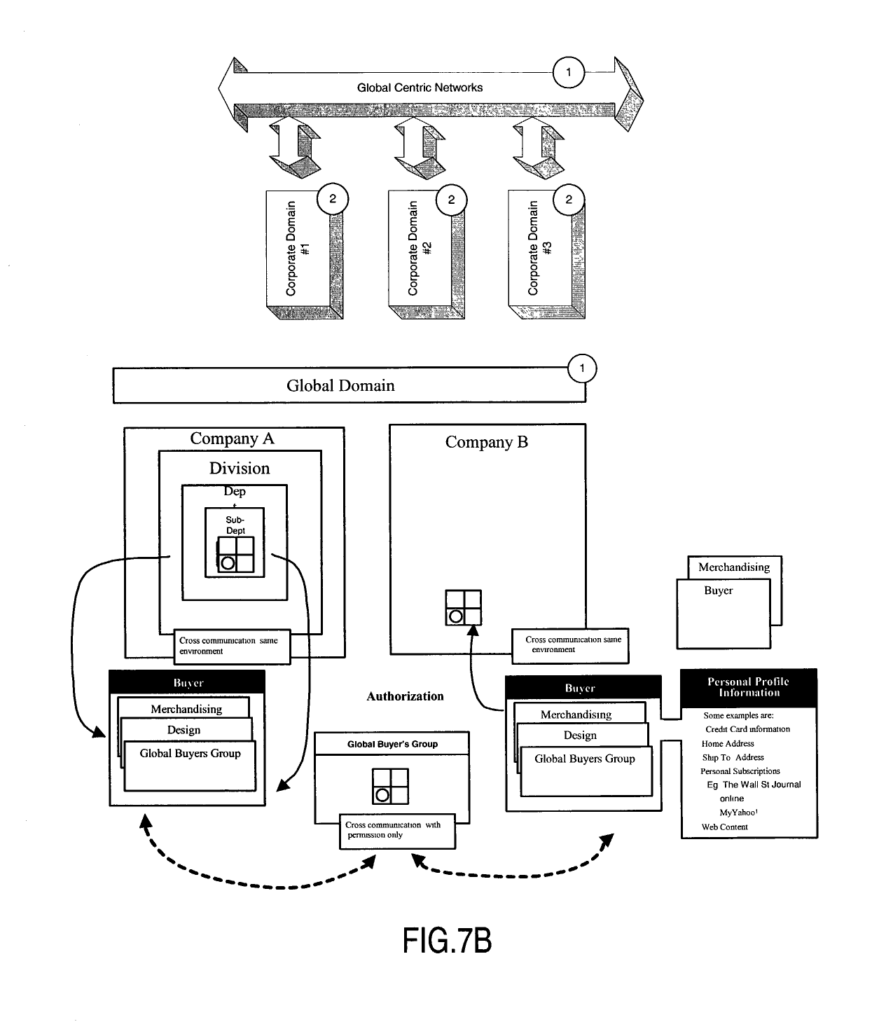

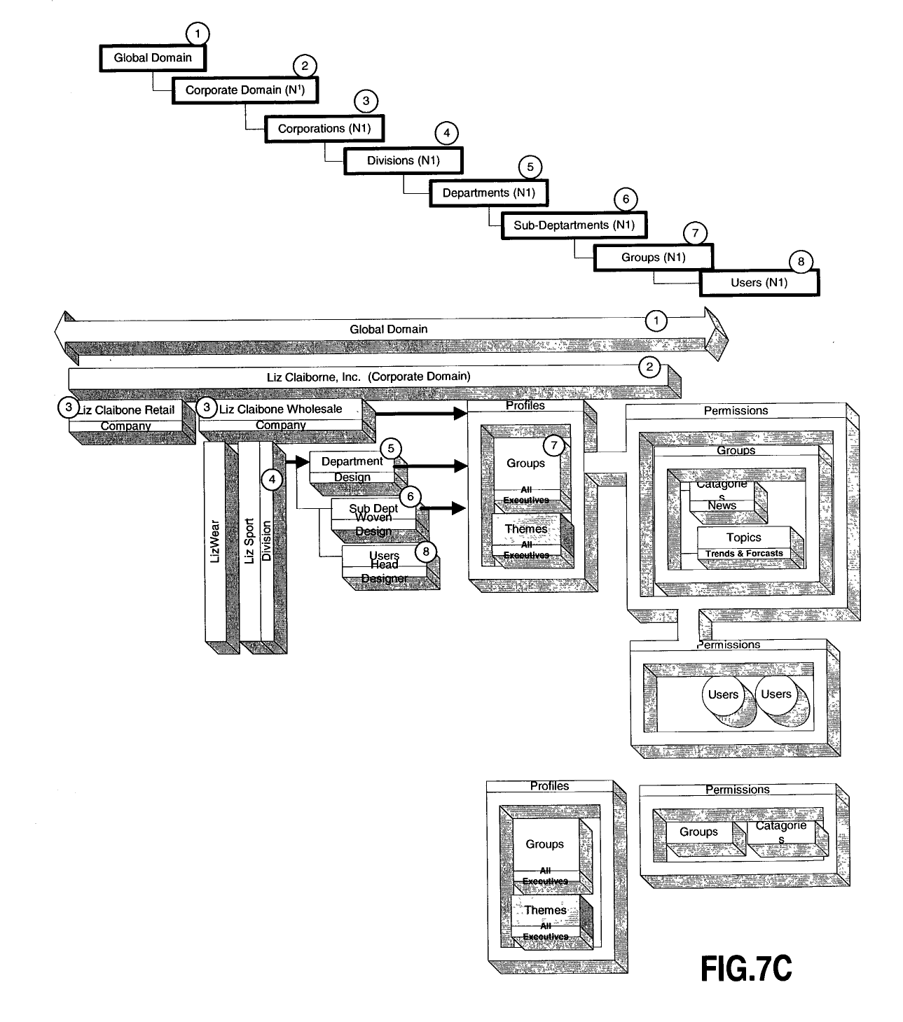

An example of the database driven “passport” feature of embodiments of the present invention will now be described by reference to FIGS. 7A-B which illustrates a schematic of the global passport concept showing how a communications system pursuant to embodiments of the present invention may be operated to allow users to communicate and collaborate across industries and vertical, applications, and industry layers. This passport bridges the divide between individuals, corporations, and every business, legal entity, and individual that may interface through an electronic mechanism. The passport operates effectively across each of the industries as well as each industries segment and lines of business/products segments as well as between individuals. Each one of the entities in set forth in the example environment of FIG. 7A can have different rights and attributes which attach themselves to the passport and are governed by both the individual and the corporation that employs the individual depending on the use.

As described above, each user is associated with a particular user identifier. Content and personal settings remain the property of the individual user (similar to a personal *.ini file). Pursuant to some embodiments, the communication system of the present invention does not inherit data outside the scope of the user's personal settings. For example, to maintain the confidentiality of company information, the communication system of the present invention does not retrieve or access company information. Security is reviewed to ensure that no company documents or files can be distributed or copied in an unauthorized manner. Pursuant to some embodiments of the present invention, and the communication system may also work in concert with a client company's existing security and network management software if it is present and available for use.

When a user leaves a “company entity”, personal settings are saved by communications server 200 and can be restored when the individual user signs up for individual membership or re-appears under a new company membership at a later point in time. Pursuant to embodiments of the present invention, a personal “passport” of user information and preferences is provided that follows the user. For example, this passport houses information associated with a user's “themes” (e.g., including the user's preferences for the look and feel of the communication interface, including information such as colors and icons for Web and desktop application interfaces and visual layout or the like), “preferences” (e.g., including application configuration information such as screen location, menu options, settings, billing and contact information or the like). FIG. 7B is a high level diagram showing the method of assigned and inherited rights for each unique entity (e.g., such as an individual user or other entity). In the example depicted in FIG. 7B, the user is a buyer within a defined administrative proofing company “A” who has rights to certain internal documents and applications issued as “permission's” within his/her individual passport (e.g., and associated with the user via user database 400 described in conjunction with FIG. 5 above). A “group” is given access to certain applications and documents. Any member of this group inherits these general rights.

The user passport regulates which documents can be accessed and modified by the member. In the example of FIG. 7B, the buyer belongs to the groups “designer”, “merchandising”, and “buying”. Each of these groups have access to particular documents and applications.

In some embodiments, the individual access rights are created by excluding certain application/documents or even news leads etc. from the user access rights. All these “passport” details are stored with his/her personal profiles (e.g., in user database 400 described in conjunction with FIG. 5 above).

A user at another company (B) can also be given permission to access certain documents and applications of company (A). That is, it allows collaborative planning of production or the performance of data exchange through the use of the communications system of the present invention. The unique identifier for each user allows for the ability to provide life time “reach-me-follow-me” capabilities. For example if a user changes his/her email address a new colleague can query the system which in turn based upon the users preferences have a IM sent to the user providing information about the person who initiated the inquiry. Upon receiving the inquiry, the user can have a reply sent back notifying the inquirer that he/she has received it and the new email address will be attached or the user can choose to automatically have an email forwarded to an email address of their choosing.

An example of a company passport authorization system directory structure is illustrated in FIG. 7C which further represents the hierarchal anatomy of the security taxonomy and structure. Pursuant to some embodiments of the present invention, each company participating in communication network 100 may sign up for a number (n) of seats and allocate those seats to employees (individual users). As defined by the domain hierarchy associated with the company (e.g., as defined in domain database 300 of FIG. 4), each employee is part of a company as well as part of a division (n) and a department, as well as a sub-department. A top-level entity (here, the entity operating communication server 200), also referred to as the “global domain” entity, is utilized, allowing collaboration and communication between different entities and within different entities. Applicants have discovered that the use of such a global domain structure allows one entity to provide a communications bridge to other entities or corporate domains. Without use of such a global domain structure, sub-domains or entities cannot communicate with other entities. For example, use of the global domain structure pursuant to embodiments of the present invention allows individuals from two different companies to communicate while preserving the security and privacy rules of each of the different companies. Communications without use of such a global domain structure results in a system in which each corporate domain remains isolated from other corporate domains and any subsets, affiliations or inheritance properties will be islands by association. Those skilled in the art will recognize that other hierarchies may also be utilized.

In the example structure of FIG. 7C, the rights of the sub-department (SDpt) are automatically assigned/inherited to each individual employee or member of that group (i.e., in the example, the set of executives). Pursuant to some embodiments, any security or administrative rights of a company can be assigned or transferred to an individual entity (user or corporation) by an authorized administrator.

Pursuant to some embodiments, personal settings are unique to the individual user and are not a part of (owned by or associated to) the corporation or a entity that any individual user may be associated with at any time during the life of their participation in communications network 100. In some embodiments, for example, a user may establish preferences causing the user to receive subscription data (e.g., a daily news clipping service or the like). Pursuant to some embodiments, these preferences may follow the user, even as he transfers within a company or between companies (providing the new company's security rights allow such content to be displayed). The company proxy server has the potential to block certain URL's even when personal accounts would be able to access them. An individual user's private account is subservient to that of the employers account settings. In some embodiments, when a user leaves a company all sponsoring corporate units and privileges are lost and remain the exclusive property of the sponsoring corporation.

Individual users in a group may only have permission to use some of the content in a group. For example, a group may allow access to a number of different items of content, but not to all members of the group. As a particular example, a user otherwise enjoying full access privileges to group data may be blocked from accessing sensitive group data (such as accounting information or HR reporting data). Other benefits and advantages of use of this passport structure of the present invention will be recognized upon reading this disclosure.

Communication Overview

Referring now to FIG. 8, a communication process 600 is shown which may be performed using embodiments of the present invention. Communication process 600 may be initiated by a user operating a user device 110 in communication with communication server 200 (e.g., as shown in FIG. 1). Pursuant to embodiments of the present invention, each user who has registered with communication server 200 may initiate and participate in communication sessions. Further, in some embodiments, prior to inviting one or more attendees to take part in a communication session, the user initiating the communication session (the “host”) may ascertain whether the attendees are available. This is shown in FIG. 8 at 602 where the host determines attendee availability.

In some embodiments, this determination is based on availability information provided by each user device 110 to communication server 200. For example, on a periodic basis (e.g., such as every minute, every 10 minutes, every half hour, etc.), each user device 110 transmits a status message to communication server 200 indicating whether the user device is online (e.g., available for participation in a communication session) or not. In some embodiments, each registered user may be associated with more than one user device 110 (e.g., a user may be associated with an office computer, a home computer, and a cellular telephone). If the office computer is on-line, a status message will be sent (e.g., initiated by communication software 122 stored at the office computer) to communication server 200 indicating that the device is online.

In some embodiments, each user may designate his availability or non-availability. For example, a user who will be out of the office and accessible only via telephone may indicate this to communication server 200. In this manner, data is stored or accessible to communication server 200 indicating the availability or non-availability of each user. In some embodiments, user availability may be further broken down into types of availability. For example, a user who only has access to a telephone for a period may be available to take part in voice communication sessions but cannot take part in text or video communication sessions. As another example, a user who does not have a video camera on his home computer may be designated as being online or otherwise available to take part in voice and text communication sessions but not in video sessions. As a further example, a user who is out of the office may be designated as not being available to participate in any communication session (even if his office computer is online).

In some embodiments, communication server 200 will deduce the availability or non-availability of an invited participant. For example, communication server 200, may receive information indicating an intent of a host or inviting user to invite one or more attendees to a communications session. Communication server 200 may utilize this information to deduce or determine the availability of each invitee. For example, this may include first retrieving the user identifier of each invitee (e.g., from database 400 of FIG. 5) and then retrieving information about particular media types supported by each user device 110 used by the user. Based on this information, server 200 can determine whether an invitee is available to participate in a particular communication session. As an example, if a user is “out of town” and only has a cellular telephone with him, the server will deduce that he is not available to participate in a collaboration session or a video conference session.

Referring again to FIG. 8, once the “host” or inviting user has determined whether his intended attendees are available (and the nature of their availability), processing continues to 604 where the host interacts with communication server 200 to cause each of the attendee(s) to be invited to a communication session. Pursuant to embodiments of the present invention, such communication sessions can be either ad hoc (e.g., without advance notice or in substantial real time) or planned (e.g., scheduled for particular time in the future with advance notice to the attendees).

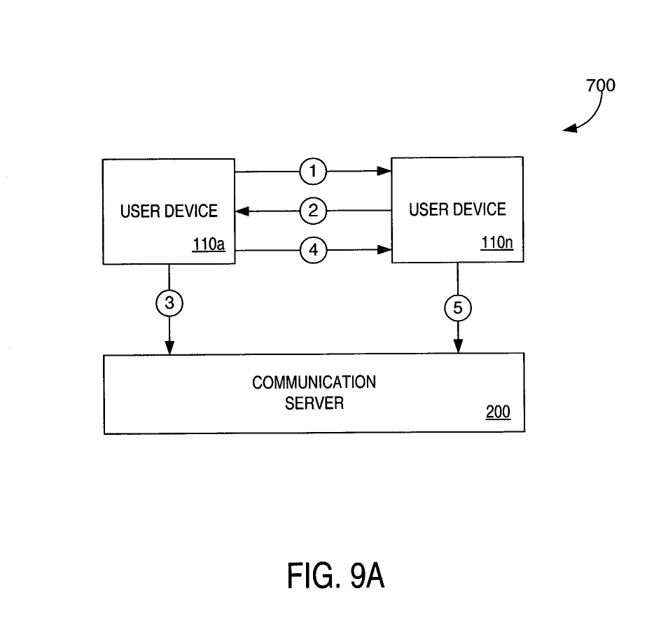

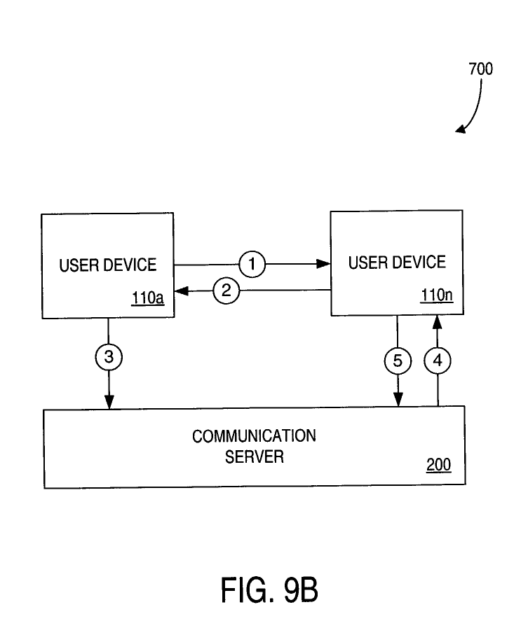

In establishing an ad hoc session, the availability information identified at 602 includes real-time or current attendee availability (e.g., is the intended attendee available to currently participate in a communication session?). Further details regarding the establishment and conduct of ad hoc sessions will be provided below in conjunction with a discussion of FIGS. 9A and 9B. In establishing a planned communication session, the availability information identified at 602 may further include future availability information (e.g., is the intended attendee going to be available to participate in a communication session at a specified future time?).

Processing at 604 includes submitting communication session information to communication server 200 and to invited attendees(s) as well. For example, if the communication session is an ad hoc session, information transmitted may include transmitting an invitation to each attendee (e.g., using instant message technologies as described further below). The invitation may include a topic and a request for participation. If the invited attendee(s) accept the invitation, communication server 200 is utilized to conduct the ad hoc session (which may include, depending on the nature of the communication, voice, video, or text communication between the participants as well as document sharing).

If the communication session is a planned session, processing at 604 may include submitting a meeting request to communication server 200 with session information such as: the time and date, the topic, a list of attendees, etc. In some embodiments, communication server 200 will generate meeting invitations and distribute them to each of the invited attendee(s). In some embodiments, this may be performed using components of communication server 200 (e.g., such as a database of users and a messaging server to transmit messages). For example, invitations may be distributed via electronic mail messages to each of the invited attendee(s) and include a link or URL allowing each attendee to point their browser or desktop application to an appropriate Web page at the time of the planned communication session. In some embodiments, invitations may be distributed using other techniques as well (e.g., such as through instant messaging, voice mail, or video mail, etc.). Information identifying planned or ad hoc communication sessions may be stored at communication server 200 (e.g., as communication data 500 of FIG. 6).

Once each of the attendee(s) has been invited, processing continues to 606 where the communication session is conducted. If the session is an ad hoc session, processing at 606 will follow shortly after processing at 602 and 604. If the session is a planned session, processing at 606 may occur some period after processing at 602 and 604. Conduct of a communication session may include a variety of forms of communication, including audio, video and text. Further, for attendees operating computing devices as their user devices, communication may also include the sharing of documents and programs. The result is an improved ability to communicate and share information among a number of differently situated participants.

Ad Hoc Communications

Reference is now made to FIGS. 9A and 9B where a schematic flow diagram is depicted showing messages which may be transmitted between devices to establish an ad hoc communication session pursuant to embodiments of the present invention. Pursuant to some embodiments, ad hoc communication sessions are established using instant messaging (“IM”) techniques. IM has become an increasingly popular mode of communication over the past years, allowing users to quickly contact other users substantially in real time.

Applicants have discovered that IM techniques (e.g., as described in IETF RFC 2778 and 2779 dated February 2000 and available at www.ietf.org, the contents of which are incorporated herein in their entirety) may be used to initiate ad hoc communication sessions pursuant to embodiments of the present invention. Referring first to FIG. 9A, a message flow diagram is shown depicting the establishment of an ad hoc communication session pursuant to some embodiments of the present invention.

As depicted, an ad hoc communication session may be established which involves a number of users operating user any number of devices as the invention can invite and create communications session with any number of the attendees using multiple devices in parallel and maintain state control consciousness over the individual session as well as over each attendee.

In the example shown, a communication session is established between two users operating user devices 110a and 110n. Processing, in one embodiment, generally follows the sequence shown. A first message (denoted as message “1” in FIG. 9A) is sent from the “host” user device 110a to the attendee user device 110n. This first message is an invitation message that may be sent to any number of user devices and/or any number of attendees 110n upon detecting the presence or availability of user device 110n (e.g., whether user device 110n is online or otherwise available to respond to an invitation). Pursuant to some embodiments, detecting the presence or availability may include checking to see if the user operating user device 110n has indicated his location (e.g., if he is at the “office” or “home” computing device, or if he is on “vacation” or “out of reach”). If the user has indicated his location and if the user device associated with that location does not support the type of communication intended by the “host”, then the session will not be established. If, however, the user device associated with the location of the invited user does support the intended type of communication, the session may be established. This detecting the presence or availability of the user may be performed, for example, by querying communication server 200 (which may check availability information in user database 400, for example).

The invitation message transmitted at “1” may include invitation information such as: the identity of the “host” sending the invitation; a meeting name; invitation text; and a meeting identifier. This invitation message is transmitted to user device 110n using IM or similar protocols, causing an invitation message to appear in substantially real time on a display device of user device 110n.

The second message (denoted as message “2” in FIG. 9A) is an accept or decline message transmitted from the attendee (the user operating user device 110n) to the host (the user operating user device 110a). In some embodiments, this accept or decline message is transmitted using IM or similar protocols, causing an accept or decline message to appear in substantially real time on a display device of user device 110a. If message “2” is an acceptance, a third message (message “3”) is automatically generated (e.g., using communication software 122 shown in FIG. 3) and transmitted to communication server 200. If message “2” is a decline, processing may halt (unless other invitees accept the invitation) and the host will receive the canceled message.

If the message was an acceptance (i.e., the user operating user device 110n is online and willing to participate in an ad hoc communication session with the user operating user device 110a), the message that is forwarded to communication server 200 (message “3”) is a meeting creation message that causes communication server 200 to establish a communication session involving the host and any attendee(s) who accepted the invitation. In some embodiments, this may include establishing a Web page or address that can be accessed by all the attendees.

A confirmation message is sent from the host (user device 110a) to the attendee (user device 110n) confirming that the ad hoc communication session is in progress. In some embodiments, this confirmation message may include an address (such as a URL) which may be visited by each attendee to participate in the ad hoc communication session. The ad hoc communication session begins once the attendee(s) join the communication session by directing their browser to a Web page established for the session by communication server 200. The result is an ability to quickly initiate and conduct communication sessions involving multiple participants. Once established the participants may communicate and interact using a variety of techniques, including audio, video, and text communication. Further, pursuant to embodiments of the present invention, participants may share, edit, and collaborate over documents, programs and data stored on any one of the participant's user device.

A further embodiment of processing which can be used to establish an ad hoc communication session pursuant to some embodiments of the present invention is shown at FIG. 9B. In the embodiment depicted in FIG. 9B, communication server 200 invites the participants at the request of the “host” user. Messages “1” and “2” indicate messages passed between the host and communication server 200 requesting the establishment of an ad hoc meeting with certain participants. For example, message “1” may include meeting information including the attendees to invite. Communication server 200, using this information, may deduce whether the invited users are available for participation in the session. For example, this may include deducing whether the invited users are at a location which will support the type of communication intended (e.g., if the meeting is to be a collaboration session requiring the use of a computing device with a display, is the invited attendee at a location with such a device?). The availability (and/or the non-availability) of each of the desired attendees may be communicated back to the host at message “2”.

If one or more of the intended participants is available to participate in the session, message “3” is transmitted from the host device (user device 110a) to communication server 200. Message “3” is a meeting invitation which includes information allowing the server to establish an ad hoc communication session. For example, message “3” may include information such as a meeting identifier, a host identifier, a meeting name, an invitation text, and one or more attendee identifiers. Communication server 200 uses this information to establish a communication session (e.g., including the generation of a Web page or secure address for the session). In some embodiments, some or all of this information may be transmitted to server 200 in message “1” at the outset.

Information identifying the session is transmitted to attendees via message “4”. Attendees join the ad hoc session (at “5”) by directing their browser to a Web page or other address indicated in message “4”. Again, the result is the ability to quickly identify if a desired participant is available (and/or if their associated user device 110 is online), and, if so, quickly joining the desired participant in an ad hoc communication session. Those skilled in the art will appreciate that similar techniques may be used to establish planned or scheduled communication sessions.

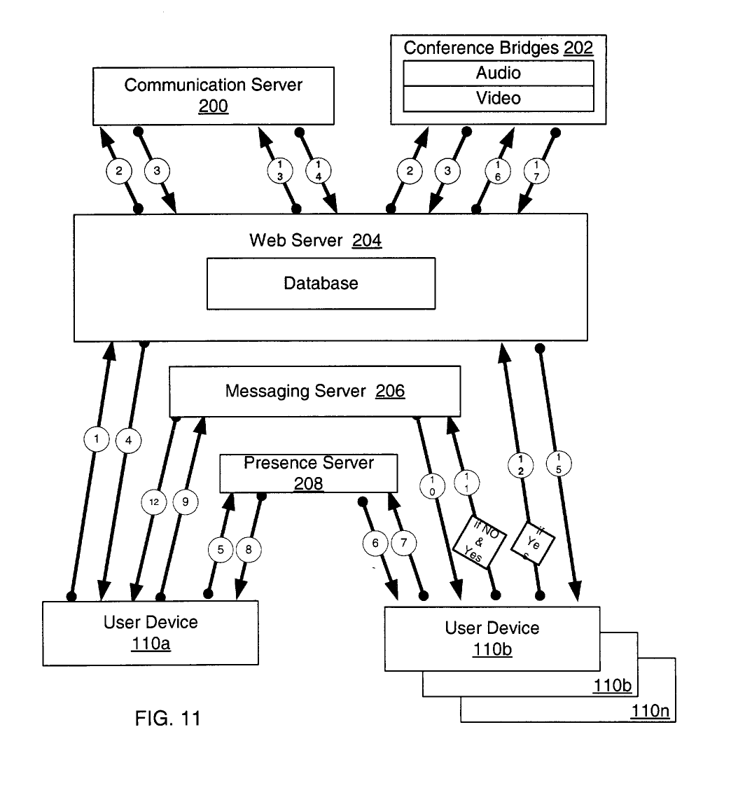

Further details of an embodiment of the present invention which may be used to establish a communication session using instant messaging techniques will now be described by reference to FIG. 11. In the embodiment depicted in FIG. 11, a communication system 1100 is shown which includes a communication server 200. In the embodiment depicted, communication server 200 is in communication with a number of sub-components, including one or more conference bridges 202, a Web server 204, a messaging server 206, and a presence server 208. Each of these components interact together as will be described to facilitate communication between users operating user devices 110a-n.

Any of a number of different components may be used for devices 200-208. For example, in some embodiments, the components are integrated on one or more UNIX or Windows NT® platforms. For example, presence server 208 may include applications from iplanet, WebLogic and JDK (or other applications which are suitable to detect device presence information). Messaging server 206 may include an Oracle® database application (or other applications which are suitable to provide messaging functionality). Web server 204 may be a Window NT®-based application including a SQL database (or other applications providing Web server functionality). Conference bridges 202 may include applications from, for example, TimesTen and/or IP UNITY (or other applications providing conference bridging functionality). In the embodiment depicted, a number of messages are passed between components to initiate a communication session using instant message technology.

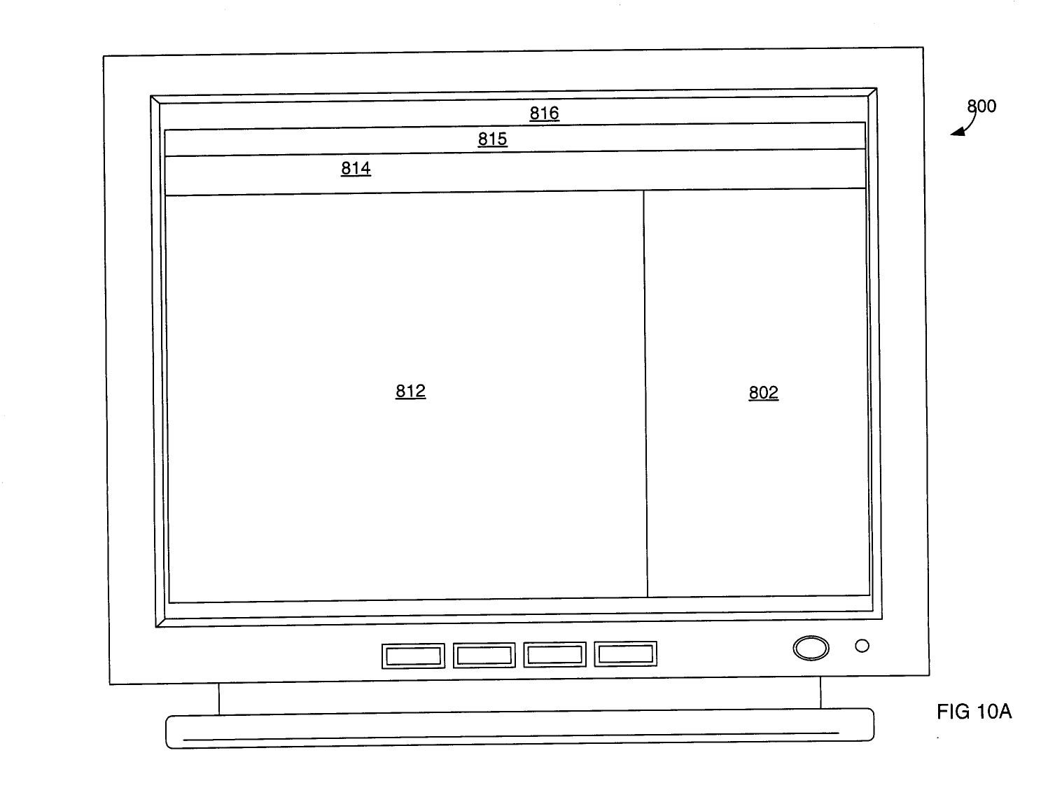

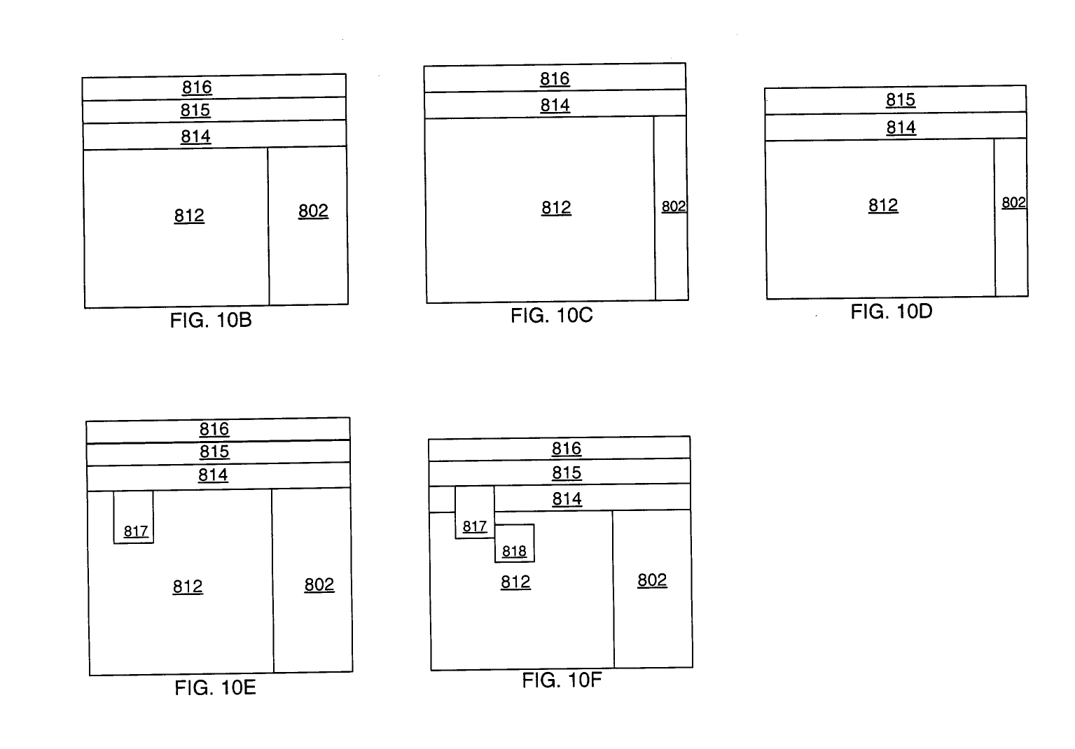

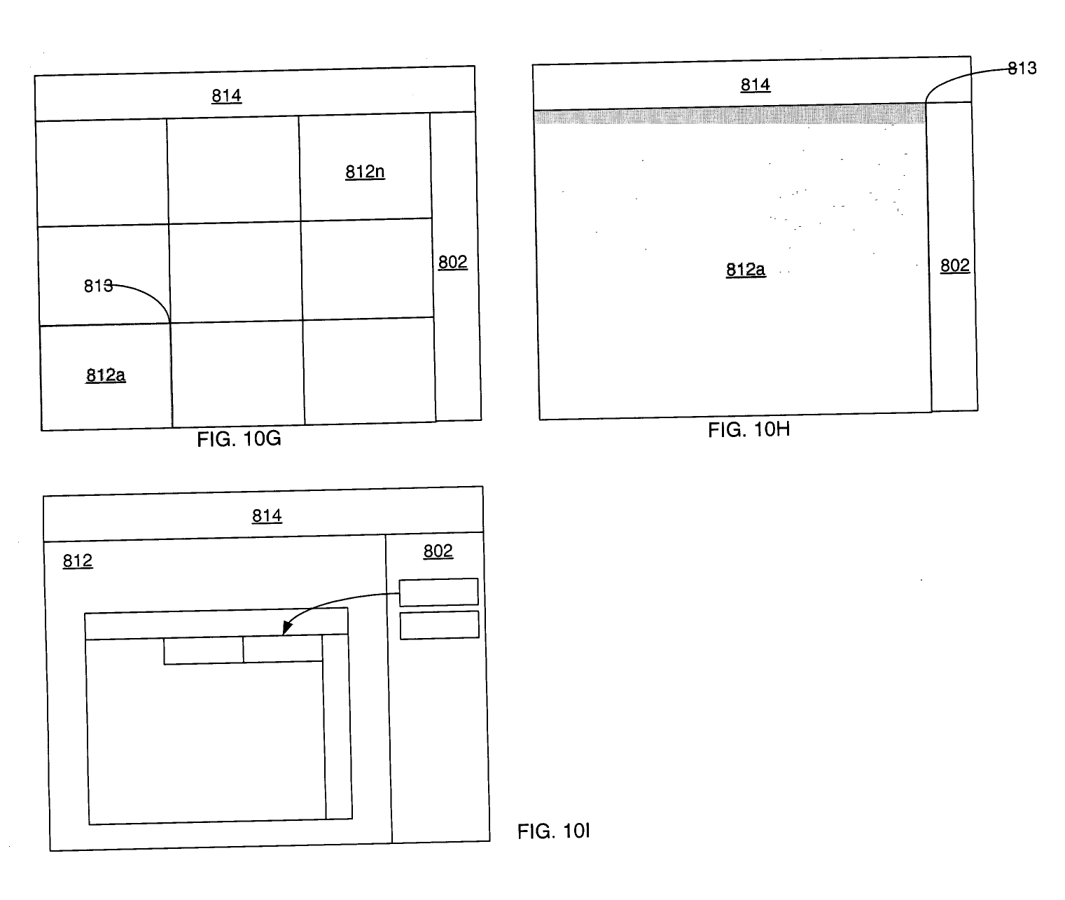

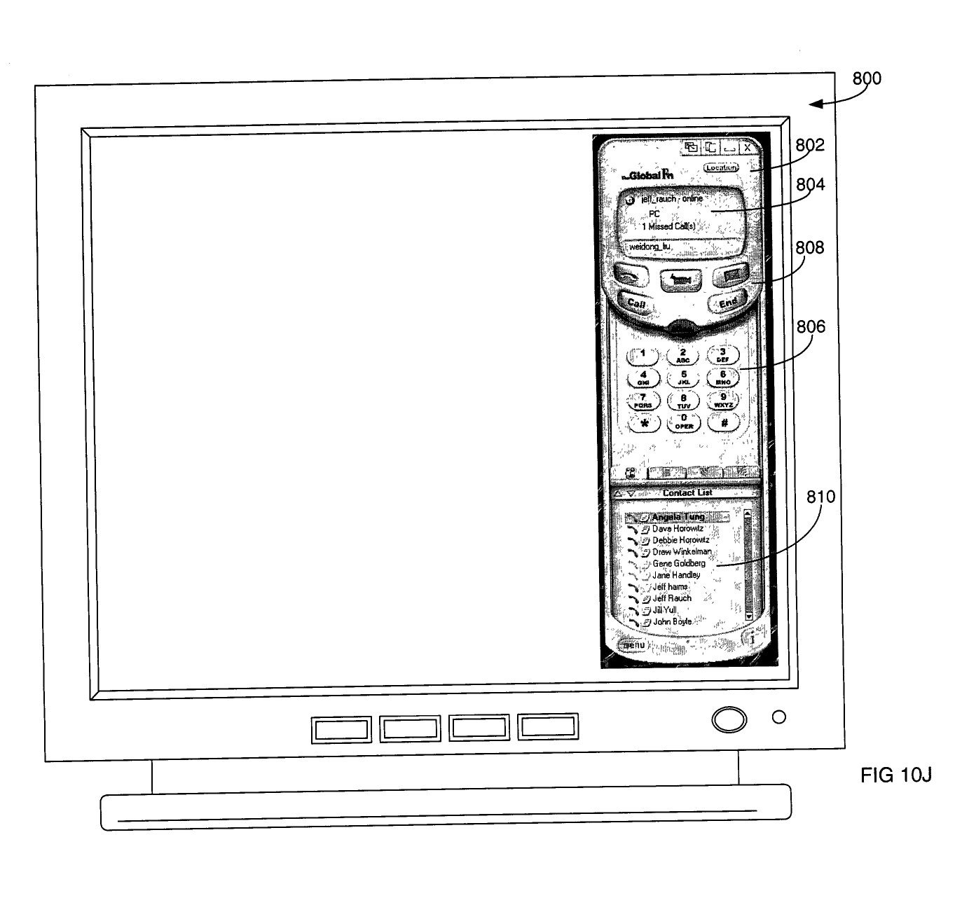

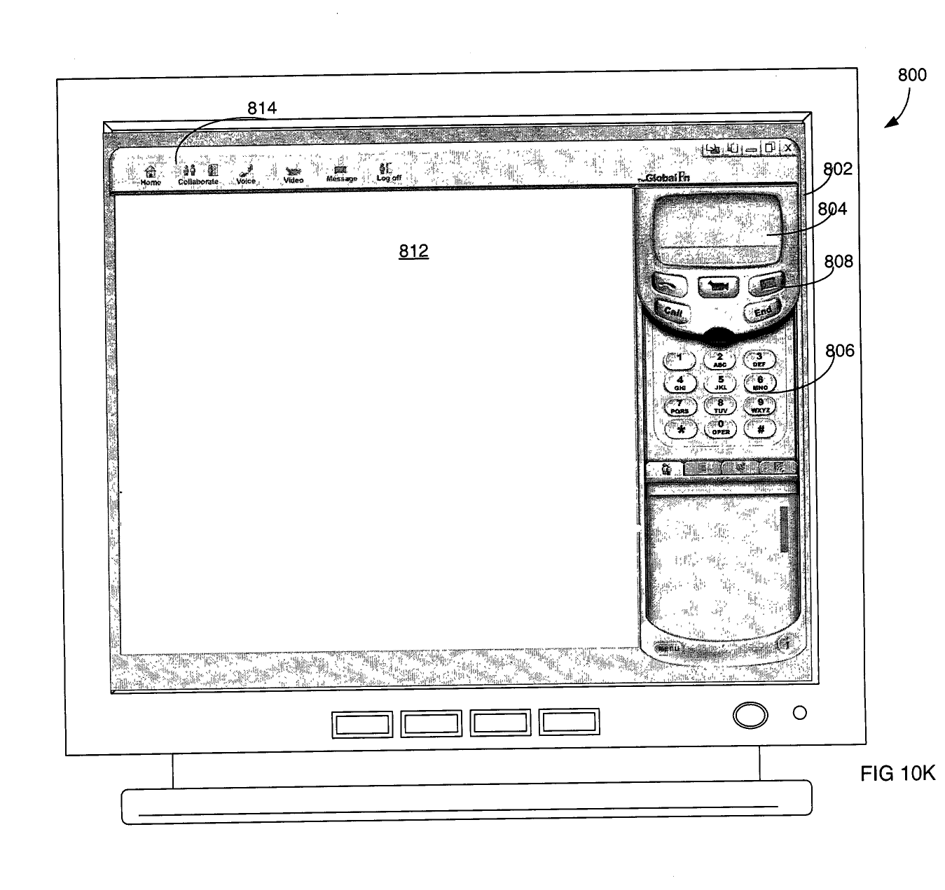

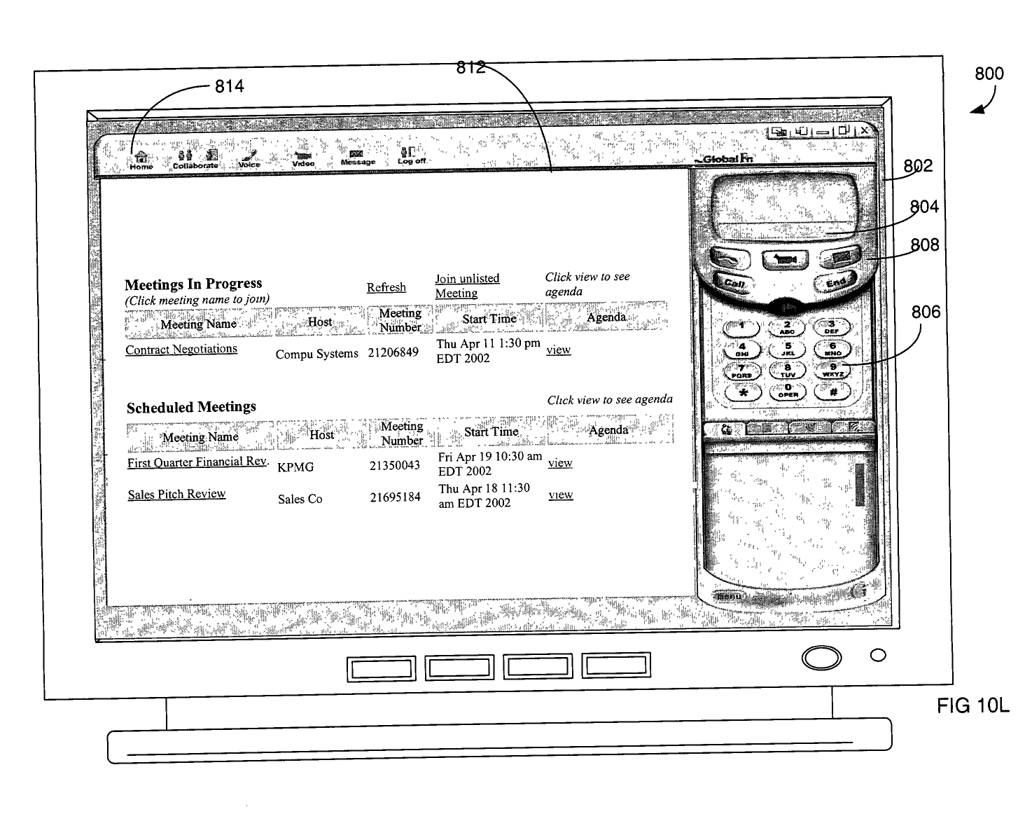

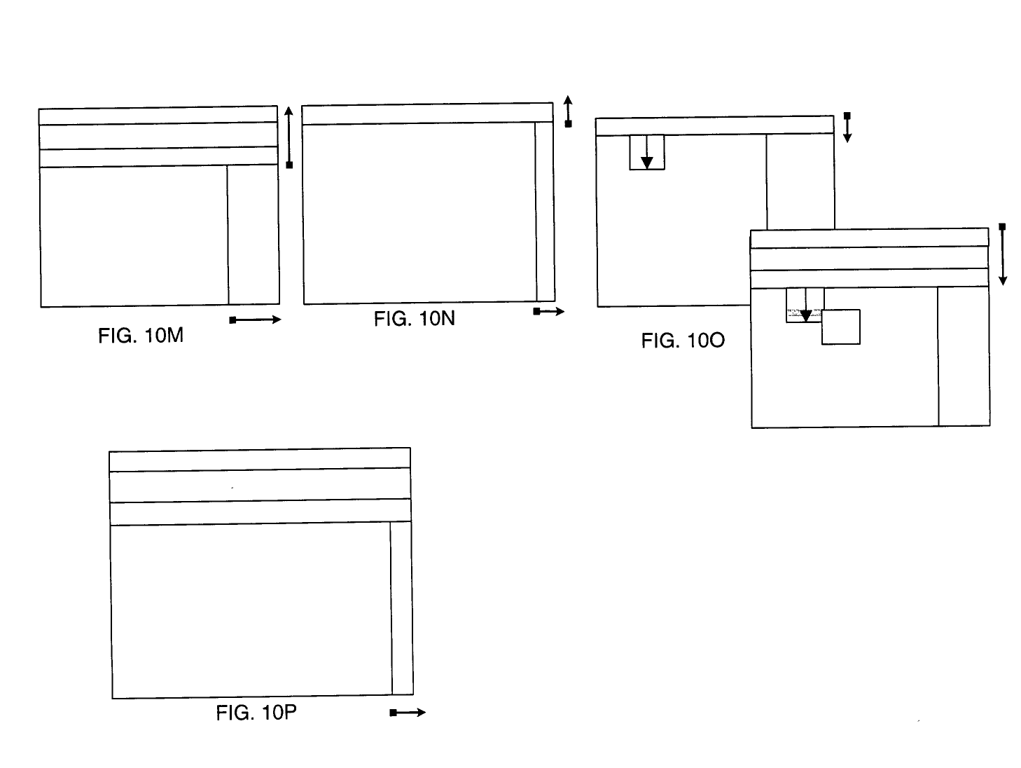

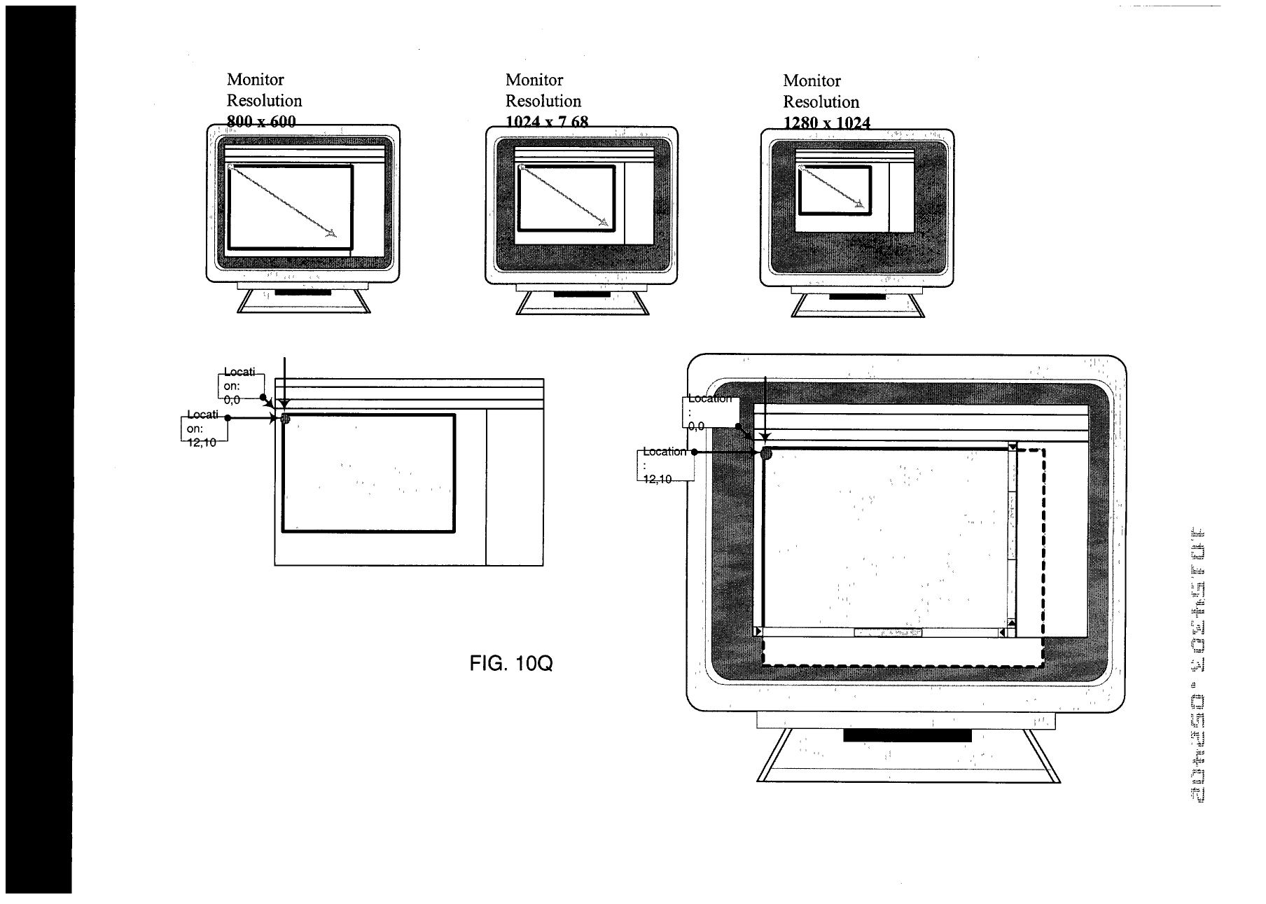

In one embodiment, an invitation is initiated when a user right-clicks in his “contact list” of a user interface (e.g., as depicted in FIG. 10 below) to select an “INVITE” function. This action will trigger a meeting request to Web server 204 and in turn causes the transmission of a “Create Meeting Request Database Query” to communication server 200. Processing continues when communication server 200 replies and a meeting is created (e.g., including the generation of messages 3 and 4 of FIG. 11).

Processing continues where the inviting user operating user device 110a checks to see if invitees (e.g., operating user devices 110b-n) are “on the air” by checking their “presence” information. This involves messages 5-8 of FIG. 11 (e.g., where presence server 208 is queried regarding the presence or non-presence of the invited users). The inviting user (operating user device 110a) has his contact list updated in real-time to indicate the presence or non-presence of each invited user.

Processing continues where the inviting user (operating user device 110a) sends an invitation to invited users (e.g., operating user devices 110b-n) through messaging server 206 (e.g., including message 9). Messaging server 206 forwards the invitation to the invited users (shown as message 10 in FIG. 11).

Processing continues where the invited users (e.g., operating user devices 110b-n) send an “ACCEPT/DECLINE” message (11) to messaging server 206. Messaging server 206 forwards the “ACCEPT/DECLINE” packet to the inviting user (the user operating user device 110a). If one or more of the invited users accepted the invitation, processing continues to message 12 where one or more invited users send a “JOIN” function query to the database engine of Web server 204. The database engine of Web server 204 sends or forwards a data query packet (message 13) to communication server 200 for confirmation of the “JOIN” function. Communication server 200 sends or forwards an acknowledge packet (message 14) to the database engine of Web server 204. This message authorizes the completion of the “JOIN” function.

The database engine of Web server 204 then sends or forwards an acknowledge packet (message 15) to each of the invited users who accepted the invitation. Processing continues where the database engine of Web server 204 sends a data query packet to the conference bridge 202 requesting video (and/or audio) conferencing services supporting communication between user 110a and each of the invited users who accepted the invitation. Initiation of the communication session is completed when conference bridge 202 forwards an acknowledge packet (message 17) back to Web server 204. Receipt of this message allows Web server 204 to initiate communication between each of the participating users. Pursuant to embodiments of the present invention, these techniques may be used to initiate communication sessions between one or more users. Communication sessions initiated in this manner may include voice, video, collaboration, or the like.

User Interaction—the “Container”

Applicants have recognized that previous communication software packages are unsuitable for communications and frequent communications. For example, previous packages are based on Microsoft Windows® “windowing” techniques where separate applications are presented in a hierarchical scheme. For example, a user who wishes to utilize a telephone application, a video application, and a conference site typically must separately open all three applications and switch between each by arranging windows (e.g., the active window is the top, visible window and the dormant applications are located beneath the active window). This can be cumbersome and can lead to a cluttered and disorganized user interface.

Embodiments of the present invention provide an improved user interface which reduces screen clutter and improves usage of available screen space and the management of multiple types of communication applications. Pursuant to embodiments of the present invention, a communication “container” in conjunction with an icon or “skin” mechanism is provided a The communication “container” integrates all communication functions into a single interface tool (e.g., audio, video, collaboration, instant messaging, etc. are each controlled using the communication “container”). The container is configured to hold and integrate existing browsers and other software applications including, for example, software and browsers produced by Microsoft, AOL, and Netscape.

Examples of this user interface will now be described by reference to FIGS. 10A-10L. Reference is first made to FIG. 10A, where a sample user interface 800 is depicted. User interface 800 may be displayed on a display device of a user device 110. User interface 800, pursuant to some embodiments, includes several sections: a control section 816 (used to allow user control of functions such as file opening or closing, editing functions, etc.), an action section 815 (used to display control icons used to initiate collaboration, voice, video, text or other communications), a text section 814 (displaying text instructions or comments regarding the content displayed in content section 812), a container section 812 (used as a “container” to display applications, software, information, or the like) and an outline or communication icon section 802 (used to initiate, control, and manage communications pursuant to the invention).

As will be described, pursuant to embodiments of the present invention, Applicants have found that this arrangement of sections allows the seamless and efficient integration of multiple communication functions in a user-friendly and intuitive manner. For example, this interface allows a user to manage a variety of communication tools, including voice communications, video communications, text or instant message communications, and collaborations or application sharing communication tools of the seamless management of other software applications. Some or all of the sections can be expanded, contracted, or hidden to effectively manage screen space and to facilitate communication using techniques of the present invention.

Reference is now made to FIGS. 10B-10F where a series of user interfaces are depicted, each having a different arrangement or sizing of sections. As depicted, each section may be sized or maneuvered to provide different configurations of user interfaces. In the interface depicted in FIG. 10B, each of the sections is in use. For example, a user may select communications functions from the communication icon 802 (e.g., the user may initiate a voice communication session, a video communication session, a text communication session, or a collaboration session by operating communication icon 802). Other sections 814-816 are also each available to the user to perform different functions. Further details of one embodiment of a communication icon will be discussed further below in conjunction with FIGS. 10J-10L.

In the interface depicted in FIG. 10C the control section 816 and the action section 815 have been collapsed and the communication icon section 802 has been reduced in size to allow the size of container section 812 to be maximized for ease of interaction and viewing.

In the interface depicted in FIG. 10D, the communication icon section 802 has been reduced. In the interface depicted in FIG. 10E, the communication icon section 802 is expanded, the action section 815 has been collapsed, and a drop down or cascading menu 817 has been activated to substitute for action section 815 (e.g., some or all of the icons which are represented in the action section 815 may be duplicated in the cascading menu 817). In this manner, valuable screen space is further preserved, allowing the action section 815 to be hidden while still allowing a user to access functions of the action section 815. In the interface depicted in FIG. 10F, the action section 815 is shown as is the cascading menu 817. Each of the interfaces of FIGS. 10B-F allow a user to access multiple communications functions in an efficient and convenient manner and that can be configured by any “permissioned” user.

Depicted in FIGS. 10M-P are a number of user interfaces pursuant to embodiments of the present invention which show various sizings and configurations which can be utilized. For example, in FIG. 10N, the main page is shown with a collapsed icon dashboard and an outline panel. In FIG. 10O, a user interface is depicted which shows a collapsed dashboard and and outline pane showing cascading menus which serve as a substitute for icons that can consume valued screen real estate. The second screen of FIG. 10O depicts further cascading menus. In FIG. 10P, a collapsed outline pane is shown. Those skilled in the art will recognize that other layouts and configurations may also be used.

Pursuant to some embodiments of the present invention, container section 812 may be held into one or more sub-containers. For example, as shown in FIG. 10G, a number of sub-containers 812a-n may be positioned in container section 812. In the example depicted, sub-container 812a is the active container. Each sub-container may be resized, for example, by dragging one or more anchors 819. In this manner, content frames can be tiled automatically and expanded to maximize screen real estate.

As shown in FIG. 10H, sub-container 812a is expanded to the full size of container section 812. Each sub-container 812a-n may be used to display and facilitate interaction with software, documents or other applications. In some embodiments, when multiple sub-window/applications 812a-n are opened, each tiles automatically to fit in the total space provided in container section 812. In this manner, a user can have several communications tools open at the same time in an efficient and user friendly manner. For example, a user may have one sub-container open displaying a shared document which is being discussed in a collaboration session with another user. A second sub-container may be open at the same time displaying a video feed displaying the other user.

As shown in FIG. 10I, each sub-window/applications may be activated using controls of communication toolbar section 802. For example, each sub-window/applications may be launched by selecting different communications functions controlled via communication icon section 802 (e.g., such as a video feed and a collaboration session, etc.). Pursuant to some embodiments of the present invention, a user can select which (if any) of the sub-window/applications other users can view in a collaboration session. For example, a user who is acting as the “host” of a collaboration session may specify that attendee users may view all sub-containers. Alternatively, the “host” can designate that some or all attendee users may view only certain sub-containers. Each display can be broken into a hierarchy of containers, including, for example, a parent container and one or more child containers. Each container can have one or more controls associated with content contained therein. Pursuant to embodiments of the present invention, these controls may be passed between participants in a communication session conducted pursuant to embodiments of the present invention. In some embodiments, a “host” in a communication session can control which content the other participants can view (e.g., the host may indicate that only certain child containers may be viewed by participants).

Reference is now made to FIG. 10J, where a particular example of communication icon 802 is shown which may be presented on a user interface 800 to a user operating a user device 110. User interface 800 includes a communication window/application 802 which may be accessible to a user of a computer by selecting the icon from the system tray or from the desktop. Once selected (as shown in FIG. 10J), the communication window/applications 802 provides a user with convenient access to a number of different communication functions. Communication icon 802 provides a number of controls which allow a user to select different communication tools.

A display screen 804 displays current communication information (e.g., such as the participant's status of “available” or “not available”, whether the user device 110 is “online” or “offline”, whether any calls are in process, whether any calls were missed, etc.). A keypad 806 is provided to facilitate telephone or voice communications. Function buttons 808 are provided to facilitate further communications functions, such as, for example, a video button to initiate video capture and viewing, a message button to retrieve voice mail messages, a telephone button to initiate a telephone call, etc.

A contact list 810 is provided for quick and selectable access to contact information and for instant messaging. Further, contact list 810 includes indications of whether each individual in the contact list is available for communication, as well as the nature of their availability. For example, in the embodiment depicted, information is provided for each individual in the contact list regarding their availability or non-availability to be contacted via voice and via text (or instant message) or other mechanisms. For example, the telephone icon next to each contact in the contact list may be highlighted to indicate that the individual is accessible via telephone or voice communication. The text icon next to each contact in the list may be highlighted to indicate that the individual is accessible for communication or communication via instant messages or other text messages. This icon can also be used to indicate whether the individual is available to take part in ad hoc communication sessions pursuant to embodiments of the present invention.

According to some embodiments, an ad hoc communication session may be initiated with available contacts by simply right clicking on the icon next to the contact's name in the buddy list and entering meeting invitation information. According to some embodiments, a scheduled communication session may be initiated in a similar manner. The result is a simple, intuitive interface that combines a variety of different communications and communication functions.

Referring now to FIG. 10K, further features of communication icon 802 are shown. In the view depicted, a container 812 has been extended from the body of communication icon 802. This container is used as a workspace for communication sessions conducted pursuant to embodiments of the present invention. As shown along the top of container 812, a number of selectable icons are presented in an action section 814 which may be used to initiate and participate in communication sessions pursuant to embodiments of the present invention.

Referring to FIG. 10L, information is depicted in container 812. This information (in the example shown) is a home page of a meeting center operated pursuant to embodiments of the present invention and listing a number of ongoing and scheduled communication sessions. Through use of the container 812 in conjunction with communication icon 802 all communication functions that a user may require are easily accessible without need to sort through hierarchical or tiled screens. Further, the look and feel and overall utility of communication icon 802 may be individually configured based on user preferences. For example, the look and feel and utility of a particular user's communication icon 802 may be configured based on user preference information stored in user database 300 (see FIG. 4 above).

Referring now to FIG. 10Q, further user interfaces are depicted to illustrate further features of some embodiments of the present invention. The user interfaces of FIG. 10Q depict some of the issues which can arise as a result of the use of different user interface devices in a communication session (e.g., one user may interact using a screen resolution of 800×600 pixels, while another may interact using a screen resolution of 1024×768, etc.). Different configurations can make it difficult for participants in a communication session to share information (e.g., to share the same document, etc.). Pursuant to embodiments of the present invention, this problem is resolved by anchoring all documents and shared information at the top left corner. This ensures that all shared or open documents are viewed consistently. Further, if a user's screen resolution is such that it requires a larger viewing area, some embodiments of the present invention automatically detect and provide scroll bars.

Although the invention has been described in detail in the foregoing embodiments, it is to be understood that the descriptions have been provided for purposes of illustration only and that other variations both in form and detail can be made thereupon by those skilled in the art without departing from the spirit and scope of the invention, which is defined solely by the appended claims.

What is claimed is:

1. A method for operating a computing device to initiate a communication session, comprising:
detecting if a desired participant is available to participate in a communication session;
transmitting an invitation to said desired participant if said desired participant is available;
receiving an acceptance from said desired participant, wherein said transmitting and said receiving are performed in substantially real time; and
upon receipt of said acceptance, automatically causing meeting information to be forwarded to a communication server, said communication server establishing said communication session involving said meeting initiator device and said desired participant.

2. The method of claim 1, wherein said detecting if a desired participant is available includes monitoring a status of said desired participant.

3. The method of claim 1, wherein said detecting if a desired participant is available includes detecting presence information associated with said desired participant.

4. The method of claim 3, wherein said detecting presence information includes periodically determining availability information associated with said desired participant to determine the availability or non-availability of said desired participant.

5. The method of claim 4, wherein said determining availability information includes:
determining a scheduled time of said communication session;
determining a location of said desired participant at said scheduled time; and
determining whether said desired participant is available at said scheduled time.

6. The method of claim 5, wherein said determining whether said desired participant is available at said scheduled time includes retrieving availability information from said communication server.

7. The method of claim 6, wherein said determining whether said desired participant is available at said scheduled time includes retrieving user device information from said communication server.

8. The method of claim 1, wherein said invitation includes information identifying a communication session.

9. The method of claim 8, wherein said invitation further includes at least one of: a meeting identifier; a date; a time; a meeting name; a meeting description; and an identifier of said desired participant.

10. The method of claim 1, wherein said acceptance includes information identifying said desired participant.

11. The method of claim 10, wherein said acceptance further includes information from said invitation including at least one of: a meeting identifier; a date; a time; a meeting name; and a meeting description.

12. A user interface displayed on a display of an electronic computing device in conjunction with a network communications software application, the user interface comprising:
an action section for presenting to the user a plurality of selectable communication type icons;
an outline section for presenting to the user a plurality of communication-related data; and
a content section including a frame for allowing the display and manipulation of a second software application by the user.

13. The user interface of claim 12, wherein at least a portion of the action section is presented in an upper portion of a display of a computing device.

14. The user interface of claim 12, wherein at least a portion of the outline section is presented in a right portion of a display of a computing device.

15. The user interface of claim 12, wherein at least a portion of the content section is presented in a lower section of a display of a computing device.

16. The user interface of claim 12, wherein the action section, the outline section and the content section do not overlap, thereby reducing an opportunity for the user to accidentally select an incorrect function on the user interface.

17. The user interface of claim 12, wherein the second software application is not required to be resident on the first computing device.

18. The user interface of claim 12, said plurality of selectable communication type icons including at least one of: an online communication icon, a video communication icon, an audio communication icon, and a text message communication icon.

19. The user interface of claim 12, said plurality of communication-related data including at least one of: a name of a party to a conference, a name of other attendees of the conference, an indication of a host of the conference; an address book comprising of addresses of other users available for the conference.

20. The user interface of claim 19, said plurality of communication-related data including a plurality of communication-related function icons, including at least one of: a telephone keypad with selectable numeric keys, a volume control, and a conference disconnect control.

21. A user interface for a network communications software application, the user interface for display on an electronic computing device, the user interface comprising:
an action section having at least a portion thereof presented in an upper half of a display of a first computing device during use of a first software application, the action section including a plurality of selectable action icons, the selection of any of which by a first user of the computing device initiates at least one of the following processes between the first user and a second user having a second computing device in communication with the first computing device over a communications network: an online communication with a productivity application, a video communication, an audio communication, and a text message communication;
an outline section having at least a portion thereof presented in a right half of the display of the first computing device, the outline section including a plurality of selectable function icons and a plurality of communications data fields, the plurality of selectable function icons comprising at least one of: a telephone keypad with selectable numeric keys, a volume control including a mute function, and a conference disconnect control; the plurality of communications data fields comprising at least one of: a name of a party to a conference, a name of other attendees of the conference, an indication of a host of the conference; an address book of comprising addresses of other users available for the conference; and
a content section having at least a portion thereof presented in a lower half of the display of the first computing device, the content section including a frame for allowing the display and manipulation of a second software application by the first user, wherein the second software application is not required to be resident on the first computing device.

22. A method for creating a user interface for a network communication software application, comprising:
generating, in a first portion of a display screen of a computing device, an action section for presenting to the user a plurality of selectable communication type icons;
generating, in a second portion of the display screen of the computing device, an outline section for presenting to the user a plurality of communication-related data; and
generating, in a third portion of the display screen of the computing device, a content section including a frame for allowing the display and manipulation of a second software application by the user.

23. The method of claim 22, wherein at least a portion of the action section is generated in an upper portion of the display screen.

24. The method of claim 22, wherein at least a portion of the outline section is generated in a right portion of the display screen.

25. The method of claim 22, wherein at least a portion of the content section is generated in a lower section of the display screen.

26. The method of claim 22, wherein the action section, the outline section and the content section do not overlap, thereby reducing an opportunity for the user to accidentally select an incorrect function on the user interface.

27. The method of claim 22, wherein the second software application is not required to be resident on the computing device.

28. The method of claim 22, wherein the second software application is resident on a second computing device in communication with the computing device over a communication network.

29. The method of claim 22 wherein a configuration of said user interface is identified based on an identity of the user.

30. The method of claim 22, said plurality of selectable communication type icons including at least one of: an online communication icon, a video communication icon, an audio communication icon, and a text message communication icon.

31. The method of claim 28, said plurality of communication-related data including at least one of: a name of a party to a conference, a name of other attendees of the conference, an indication of a host of the conference; an address book of comprising addresses of other users available for the conference.

32. The method of claim 31, said plurality of communication-related data further including a plurality of communication-related function icons, including at least one of: a telephone keypad with selectable numeric keys, a volume control, and a conference disconnect control.

33. The method of claim 28, said second software application comprising a productivity application including at least one of: a word processing application, a publishing application, a spreadsheet application, a financial accounting application, a computer aided design application and a multimedia editing application.

34. A method for initiating an online conference using a network communication software application on a first computing device, comprising:
selecting a communication type icon for initiating one of the following processes of an online conference: an online communication of a productivity application, a voice communication, a video communication and a text messaging communication;
selecting an attendee for the online conference; and
transmitting a text message for display on a computing device of the selected attendee, wherein the attendee may select an alternate destination for the display of the text message when the attendee is not using a second computing device having a network address assigned to the attendee.

35. The method of claim 34, said selecting a communication type icon further comprising:
selecting the communication type icon from an action section of a display of the first computing device.

36. The method of claim 35, wherein at least a portion of the action section is generated in an upper portion of the display.

37. The method of claim 34, said selecting an attendee further comprising:
selecting the attendee from a list of attendees available on the network provided in an outline section of a display of the first computing device.

38. The method of claim 37, wherein at least a portion of the outline section is generated in a right portion of the display.

39. The method of claim 34, wherein the action section and the outline section do not overlap, thereby reducing an opportunity for the user to accidentally select an incorrect function of the network communication software application.

40. A method for facilitating communications between a plurality of users, comprising:
establishing a first user using a first computing device as a moderator of an online conference;
establishing a second user using a second computing device as an attendee of the online conference;
receiving, from the moderator, an indication of a software application and content managed by the software application to make available to the attendee, the software application resident on the first computing device; and
receiving from the attendee a revision to the content generated in a content section of a display of the second computing device during the online conference.

41. The method of claim 40, wherein the at least one application is not resident on the second computing device.

42. The method of claim 40, further comprising:
assigning a first color for a revision to the content made by the host during the conference.

43. The method of claim 42, further comprising:
assigning a second color for the revision to the content made by the attendee.

44. The method of claim 40, further comprising:
receiving an instant message generated by the host for inviting the attendee to the online conference, the instant message having an electronic address corresponding to the second computing device; and
forwarding the instant message to a device selected by the attendee.

45. The method of claim 40, further comprising:
generating a list of available conferences; and
presenting the list of available conferences to the host in a home page assigned to the host.

46. The method of claim 40, further comprising:
transmitting, to the host, a software client for initiating the online conference, if the software client is not resident on the first computing device.

47. The method of claim 40, further comprising:
transmitting, to the attendee, a software client for participating in the online conference, if the software client is not resident on the second computing device.

48. The method of claim 40, further comprising:
receiving, from the host, a command to establish the attendee as host of the online conference;
establishing the second user as the host of the online conference; and
establishing the first user as the attendee of the online conference.

49. The method of claim 40, wherein other software applications on the first computing device are not accessible to the second user.

50. The method of claim 40, further comprising:
receiving, from the host, an indication of at least one further software application resident on the first computing device that is to be made available to the attendee.

51 The method of claim 50, wherein the software application operates on an operating platform that is different from an operating platform of the second computing device.

52. The method of claim 40, further comprising:
receiving, from the host, an agenda for the online conference.

53. The method of claim 52, further comprising:
displaying the agenda to the attendee.

54. The method of claim 40, further comprising
receiving from the host, a designation that the online conference is a public conference, wherein further users of the network may receive a listing of at least the time of the conference on a web page.

55. The method of claim 40, further comprising:
receiving from the host, a designation that the online conference is a private conference, wherein further users of the network can not view a listing of the conference on a web page.

56. A method for initiating an online conference, performed by a user, the method comprising:
establishing a time for an online conference;
establishing a communication type for the online conference;
inviting at least one attendee to the conference; and
providing access to a productivity application to the attendee, wherein the productivity application is not resident on a computing device operated by the attendee.

57. A computer program product for interfacing with a website, said computer product comprising:
a computer usable medium having computer readable program code means embodied in said medium for causing a series of steps to provide controlled simultaneous availability of a series of internet or extra net sites, said computer program product having:
computer readable program code means for causing a computer to effect the establishment of a series of individual passwords and group related passwords;
computer readable program code means for causing said computer to receive an input request from a user for access to a particular grouping of said series of sites;
computer readable program code means for causing said computer to request at least one password from said user;
computer readable program code means for causing said computer to compare said at least one password from said user with said established individual and group passwords;
computer readable program code means for providing to said user access to selected sites based on said users request and the result of said comparison of said at least one password with said established passwords;
computer readable program code means for causing said selected sites to be accessible to said user in the form of a simultaneous screen divided display; and
computer readable program code means for allowing said user to control the visual presentation of said selected sites including the modification of said visual display to select displayed information from ones of said selected sites in a separately user formed home site.
